(19) United States
(12) Patent Application Publication
(10) Pub. No.: US 2022/0175607 A1
(43) Pub. Date: Jun. 9, 2022

(54) MOTION TRAINING APPARATUS

(71) Applicants: UNIVERSITY OF YAMANASHI, Yamanashi (JP); CANON FINETECH NISCA INC., Yamanashi (JP)

(72) Inventors: Yoshiyuki NODA, Yamanashi (JP); Tatsuya OHMORI, Yamanashi (JP)

(21) Appl. No.: 17/537,731

(22) Filed: Nov. 30, 2021

(30) Foreign Application Priority Data
Dec. 3, 2020 (JP) 2020-200787

(51) Int. Cl. A61H 1/02

(52) U.S. Cl. CPC A61H 1/0274; A61H 2201/1207; A61H 2201/5066; A61H 2201/5061

(57) ABSTRACT

To provide a motion training apparatus capable of appropriately continuing motion training. A controller of a motion training apparatus detects a position of an operation unit moving in an XY plane and controls an X-axis direction drive motor and a Y-axis direction drive motor in accordance with a first speed vector based on a magnitude of a resultant force F₀ of a force Fx in an X-axis direction and a force Fy in a Y-axis direction detected by a force sensor when the position of the operation unit is within a predetermined target area TR, and controls the X-axis direction drive motor and the Y-axis direction drive motor so that the operation unit moves in accordance with the first speed vector and a second speed vector acting to return the operation unit.

### TECHNICAL FIELD

The present invention relates to a motion training apparatus, and more particularly, to a motion training apparatus capable of supporting planar motion of a user.

### BACKGROUND ART

Conventionally, various motion trainings have been carried out in order to improve a motor function of a person. For example, wiping training in which shoulders and elbows are bent and extended by motion such as wiping a desk, and sanding training in which hands are slid up and down on an inclined board are widely performed. Various motion training apparatuses have been proposed to support such motion training.

For example, the present inventors have proposed a motion training apparatus in which an operation unit operated by a user is movably driven in an XY plane by X-axis and Y-axis direction drive motors, forces in the X-axis and Y-axis directions acting on the operation unit are detected, and a drive amount of each drive motor is limited according to a magnitude of a resultant force obtained by combining the detected forces (e.g., see Patent Document 1). By controlling both drive motors in this way, static friction is simulatively generated on the operation unit, and the operation unit is prevented from moving from a stationary state unless the user applies a force equal to or larger than a certain level. When the operation unit is stopped after starting to move, a virtual static force is exerted to eliminate the strangeness that the operation unit stops smoothly.

### PRIOR ART DOCUMENT

### Patent Document

Patent Document 1: Japanese Patent Application Laid-Open No. 2020-089621

### DISCLOSURE OF INVENTION

### Problems to be Solved by the Invention

The motion training apparatus disclosed in Patent Document 1 includes an active training mode for the purpose of causing a user himself/herself to move the operation unit so as to trace a target trajectory. In order to perform appropriate motion training for the user in the active training mode, it is preferable to assist the user to operate the operation unit so that the operation unit does not largely deviate from the target trajectory.

Therefore, the motion training apparatus of Patent Document 1 performs control so as to stop the movement of the operation unit, during motion training in the active training mode, when the operation unit deviates from the target trajectory by a predetermined range or more or a load received by the operation unit from the user is detected and becomes a predetermined magnitude or larger. However, if the operation of the motion training apparatus is frequently stopped in mid-course, there is a fear that the execution of appropriate motion training may be hindered.

In view of the problems of the related art described above, it is an object of the present invention to provide a motion training apparatus capable of appropriately continuing motion training even when the operation unit is moved as being deviated from a target trajectory set in advance during motion training in an active training mode.

### Means for Solving the Problem

A motion training apparatus of the present invention includes an operation unit configured to be movable in an XY plane, a drive unit including an X-axis direction drive motor and a Y-axis direction drive motor, and configured to drive the operation unit in the XY plane, a force sensor configured to detect a force Fx in an X-axis direction and a force Fy in a Y-axis direction acting on the operation unit from a user operating the operation unit a position detection means configured to detect a position of the operation unit in the XY plane, and a controller configured to control the X-axis direction drive motor and the Y-axis direction drive motor.

Here, the controller controls the X-axis direction drive motor and the Y-axis direction drive motor in accordance with a first speed vector based on a magnitude of a resultant force F₀ of the force Fx in the X-axis direction and the force Fy in the Y-axis direction detected by the force sensor when the position detection means detects that the position of the operation unit moving in the XY plane due to operation of the user is within a predetermined area, and controls the X-axis direction drive motor and the Y-axis direction drive motor so that the operation unit moves in accordance with the first speed vector and a second speed vector acting to return the operation unit into the predetermined area when the position detection means detects that the position of the operation unit moving in the XY plane due to operation of the user is outside the predetermined area.

### Advantageous Effect of the Invention

According to the motion training apparatus of the present invention, the controller controls the X-axis direction drive motor and the Y-axis direction drive motor, owing to the position of the operation unit moving in the XY plane, in accordance with the first speed vector based on the magnitude of the resultant force F₀ of the force Fx in the X-axis direction and the force Fy in the Y-axis direction detected by the force sensor or in accordance with the first speed vector and the second speed vector acting to return the operation unit into the predetermined area. Therefore, appropriate motion training can be continued while ensuring safety in use even when the operation unit is deviated from a target trajectory set in advance during motion training in an active training mode.

### BRIEF DESCRIPTION OF DRAWINGS

FIG. 1 is an external perspective view of a motion training apparatus according to an embodiment to which the present invention is applicable.

FIG. 2 is a perspective view of an apparatus main body of the motion training apparatus of the embodiment.

FIG. 3 is a sectional view of the apparatus main body taken along line III-III in FIG. 2.

FIG. 4 is a sectional view of the apparatus main body taken along line IV-IV in FIG. 2.

FIG. 5 is an exploded perspective view of an actuator mechanism of the motion training apparatus.

FIG. 6 is a partially enlarged view of a Y-axis direction actuator of FIG. 3.

FIG. 7 is a partially enlarged view of an X-axis direction actuator of FIG. 4.

FIG. 8 is a plan view of the actuator mechanism showing a movable range of an operation unit.

FIG. 9 is a plan view of the actuator mechanism when the operation unit is positioned at a home position.

FIG. 10 is an explanatory diagram showing the relationship of a control mode of a drive motor of the actuator mechanism with respect to a force sense indication area and a safety measure area.

FIG. 11 is a block diagram of a controller of the motion training apparatus.

FIG. 12 is an explanatory diagram of admittance control executed by the controller.

FIGS. 13A and 13B are explanatory diagrams of drive motor control performed by the controller, in which FIG. 13A shows a concept of the drive motor control, and FIG. 13B shows the drive motor control in the present embodiment.

FIGS. 14A to 14C are explanatory diagrams showing the relationship between a static friction area and each vector of the forces acting on the operation unit in the X-axis direction and in the Y-axis direction and the resultant force of the both. FIG. 14A shows a case in which all of the vectors of the forces in the X-axis and Y-axis direction and the resultant force are within the static friction area, FIG. 14B shows a case in which the vectors of the forces in the X-axis and Y-axis direction are within the static friction area and the vector of the resultant force is outside the static friction area, and FIG. 14C shows a case in which the vector of the force in the Y-axis direction is within the static friction area and the vector of the force in the X-axis direction and the vector of the resultant force are outside the static friction area.

FIG. 15 is a flowchart of a trajectory setting routine executed by a CPU of an MCU of the controller.

FIG. 16 is a flowchart of a load detection routine executed by the CPU of the MCU of the controller.

FIG. 17 is a flowchart of a motion training routine executed by the CPU of the MCU of the controller.

FIG. 18 is a flowchart of a drive command processing subroutine showing the details of S322 of the motion training routine.

FIG. 19 is a flowchart of the drive command processing subroutine showing the details of S336 of the motion training routine.

FIG. 20 is a schematic diagram of trajectory-load information displayed on a display device in the load detection routine.

FIG. 21 is a schematic diagram of motion training trajectory-load information displayed on the display device in the motion training routine.

FIG. 22 is a schematic diagram of a radar chart of load variation displayed on the lower part of a screen of the display device in the motion training routine of the motion training apparatus according to another embodiment to which the present invention is applicable.

FIG. 23 is graphs showing, in chronological order, the force acting on the operation unit, the speed of the operation unit, and the position of the operation unit in the X-axis direction and the Y-axis direction when a test is performed under conditions of Example.

FIG. 24 is a trajectory of the operation unit 3 when the test is performed under the conditions of Example.

FIG. 25 is graphs showing, in chronological order, the force acting on the operation unit, the speed of the operation unit, and the position of the operation unit in the X-axis direction and the Y-axis direction when a test is performed under conditions of Comparative Example 1.

FIG. 26 is the trajectory of the operation unit 3 when the test is performed under the conditions of Comparative Example 1.

FIG. 27 is graphs showing, in chronological order, the force acting on the operation unit, the speed of the operation unit, and the position of the operation unit in the X-axis direction and the Y-axis direction when a test is performed under conditions of Comparative Example 2.

FIG. 28 is the trajectory of the operation unit 3 when the test is performed under the conditions of Comparative Example 2.

FIG. 29 is an explanatory diagram showing a target trajectory TL of the operation unit set by the controller in the motion training mode and an operation trajectory AL on which the operation unit actually moves due to the operation of the user performing the motion training.

FIG. 30 is a circuit block diagram for explaining the drive motor control of the operation unit performed by the controller in the motion training executed in the passive training mode.

FIG. 31 is a diagram for explaining the relationship between the force acting on the operation unit and the speed vector in a case in which the input value from the operation unit to a force sensor is within a predetermined range at a trajectory position LP0 in FIG. 29.

FIG. 32 is a diagram for explaining the relationship between the force acting on the operation unit and the speed vector in a case in which the input value from the operation unit to the force sensor exceeds the predetermined range at the trajectory position LP0 in FIG. 29.

FIG. 33 is a diagram for explaining the relationship between the force acting on the operation unit and the speed vector in a case in which the input value from the operation unit to the force sensor exceeds the predetermined range at a trajectory position LP1 in FIG. 29.

FIG. 34 is a diagram for explaining the relationship between the force acting on the operation unit and the speed vector in a case in which the input value from the operation unit to the force sensor exceeds the predetermined range at a trajectory position LP2 in FIG. 29.

FIG. 35 is a diagram for explaining the relationship between the force acting on the operation unit and the speed vector in a case in which the input value from the operation unit to the force sensor exceeds the predetermined range and exceeds a predetermined value at the trajectory position LP2 in FIG. 29.

FIG. 36 is a circuit block diagram for explaining the drive motor control of the operation unit performed by the controller in the motion training executed in the active training mode.

FIG. 37 is a diagram for explaining the relationship between the force acting on the operation unit and the speed vector at the start of motion training in the active training mode.

FIG. 38 is a diagram for explaining the relationship between the force acting on the operation unit and the speed vector in a case in which the position of the operation unit operated by the user in the active training mode is within a predetermined target area.

FIG. 39 is a diagram for explaining the relationship between the force acting on the operation unit and the speed vector in a case in which the position of the operation unit operated by the user in the active training mode is outside the predetermined target area.

FIG. 40 is a diagram for explaining the relationship between the force acting on the operation unit and the speed vector in a case in which the position of the operation unit operated by the user in the active training mode returns into the predetermined target area after deviating from the predetermined target area.

FIG. 41 is a diagram for explaining the relationship between the force acting on the operation unit outside the predetermined target area and the speed vector in another embodiment in the active training mode.

FIG. 42 is a diagram for explaining the relationship between the force acting on the operation unit outside the predetermined target area and the speed vector in further another embodiment in the active training mode.

FIG. 43 is a diagram for explaining the relationship between the force acting on the operation unit returned to the predetermined target area and the speed vector in the embodiment of FIG. 42.

### MODE FOR CARRYING OUT THE INVENTION

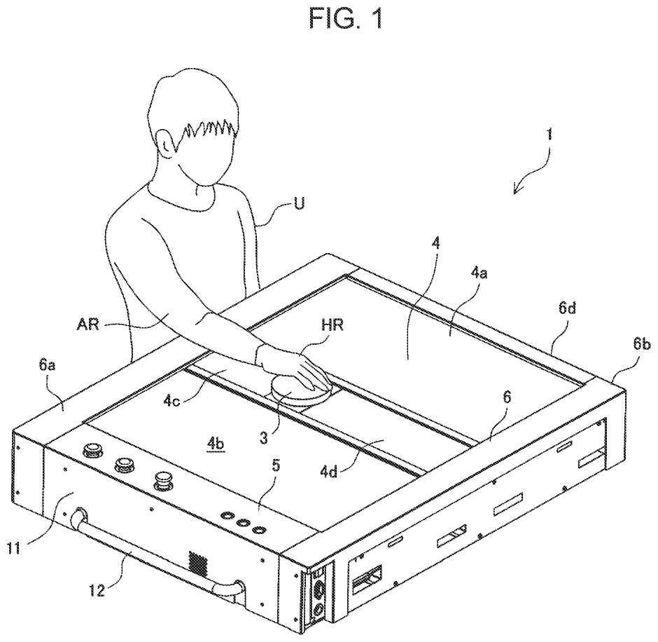

In the following, embodiments of a motion training apparatus applicable to the present invention will be described with reference to the drawings. The motion training apparatus of the embodiment is placed on a substantially horizontal placement surface, and is used for, for example, motion training to be performed for the purpose of improving the motor function of the upper limb of a user (motion trainee) (see FIG. 1).

### 1. Configuration

### 1.1. Mechanism Section

### 1.1.1. Outline of Mechanism Section

A motion training apparatus 1 includes an operation unit 3 which is movable in an XY plane (see FIG. 1), an X-axis direction drive motor 38, a Y-axis direction drive motor 30, an actuator mechanism 20 for driving the operation unit 3 in the XY plane (see FIG. 5), and a force sensor 51 for detecting forces in the X-axis and Y-axis directions acting on the operation unit 3 (see FIG. 5). The X-axis and Y-axis direction drive motors 38, 30 are integrally configured with encoders 38a, 30a for detecting the position of the operation unit 3 in the XY plane (see FIG. 5), respectively. These members except for the operation unit 3 are accommodated in a housing 5, and the operation unit 3 (a handle member 49 thereof; see FIG. 5) protrudes upward from the housing 5 (see FIG. 1).

### 1.1.2. Details of Mechanism Section

### (1) Housing 5

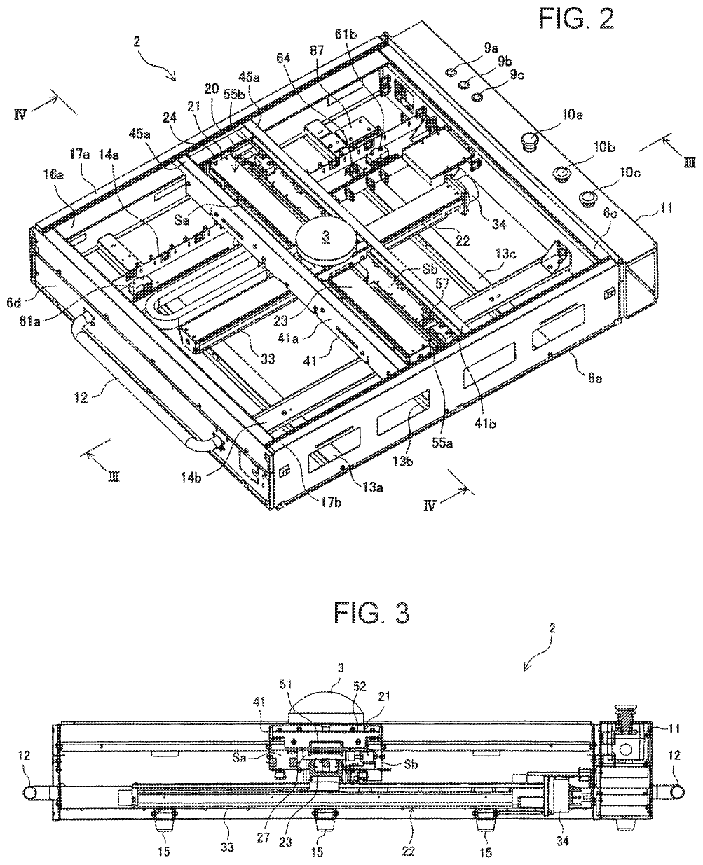

As shown in FIGS. 1 and 2, the housing 5 is configured by a substantially box-like casing 6 having the upper portion thereof opened and a rectangular frame-shaped outer frame 11. FIG. 1 shows a state in which a user (motion trainee) U is positioned in front of the motion training apparatus 1 and extends the right arm AR forward to operate the operation unit 3 with the right hand HR in order to perform, for example, wiping training. FIG. 2 shows an apparatus main body 2 in a state in which a cover 4 is removed from the motion training apparatus 1 shown in FIG. 1, and the near side in the drawing is the front face side and the far side is the rear face side of the motion training apparatus 1.

### A) Casing 6

The casing 6 includes a front frame 6a, a rear frame 6b (see FIG. 1), a right frame 6c (see FIG. 2), and a left frame 6d (see FIG. 1) each having the upper and lower end parts bent in a substantially U-shape, and a bottom frame 6e (see FIG. 2) arranged on the bottom side of these frames 6a to 6d.

The casing 6 is reinforced by a plurality of reinforcement members. That is, as shown in FIGS. 2 to 4, in the casing 6, three front-rear reinforcement members 13a to 13c extending in the front-rear direction are arranged in parallel as being spaced apart in the left-right direction, and both end parts thereof are respectively fixed to the lower end part of the inner wall (front frame 6a, rear frame 6b) of the casing 6. Further, two left-right reinforcement members 14a, 14b extending in the left-right direction in the casing 6 perpendicular to the front-rear reinforcement members 13a to 13c are arranged in parallel as being spaced apart in the front-rear direction, and both end parts thereof are respectively fixed to the lower end part of the inner wall (right frame 6c, left frame 6d) of the casing 6.

The left-right reinforcement members 14a, 14b are arranged on the front-rear reinforcement members 13a to 13c, and are integrated by screw fastening. Here, a plurality of legs 15 for placing the motion training apparatus 1 on a mounting surface protrude from the bottom surface of the casing 6 corresponding to the positions of the front-rear reinforcement members 13a to 13c and the center part of the bottom surface of the outer frame 11.

### B) Outer Frame 11

As shown in FIG. 2, the outer frame 11 is reinforced by a diagonally arranged reinforcement plate. Three state indication lamps for indicating the state of the motion training apparatus 1 and three manual operation buttons are arranged on the upper surface of the outer frame 11. The three state indication lamps include a green LED 9a which is turned on during operation of the motion training apparatus 1, a white LED 9b which is turned on while the operation unit 3 is moving to a home position, and a red LED 9c which is turned on during stop of operation of the motion training apparatus 1 after power is turned on. On the other hand, the three manual operation buttons include an emergency stop button 10a for stopping the operation of the operation unit 3 in an emergency, a pause button 10b for temporarily stopping the operation of the operation unit 3, and an initialization button 10c for positioning the operation unit 3 at the home position.

The outer frame 11 is fixed to the right frame 6c configuring the casing 6 at a plurality of positions by screw fastening, and communication windows for wiring are formed in the outer frame 11 and the casing 6. Further, as shown in FIGS. 1 and 2, a substantially horizontal bar-like handle 12 for carrying the motion training apparatus 1 is attached to the outer side surface of each of the left frame 6d configuring the casing 6 and the outer frame 11.

### (2) Cover 4

As shown in FIG. 1, the upper opening of the casing 6 is substantially entirely covered by the cover 4, and the operation unit 3 is arranged to protrude from the upper surface of the cover 4. The cover 4 is configured of a left cover 4a, a right cover 4b, a front cover 4c, and a rear cover 4d. The covers 4a to 4d are arranged in the front-rear and left-right directions of the operation unit 3, respectively, and are each formed of a bellows-structured sheet-like member which can expand and contract in accordance with the movement of the operation unit 3.

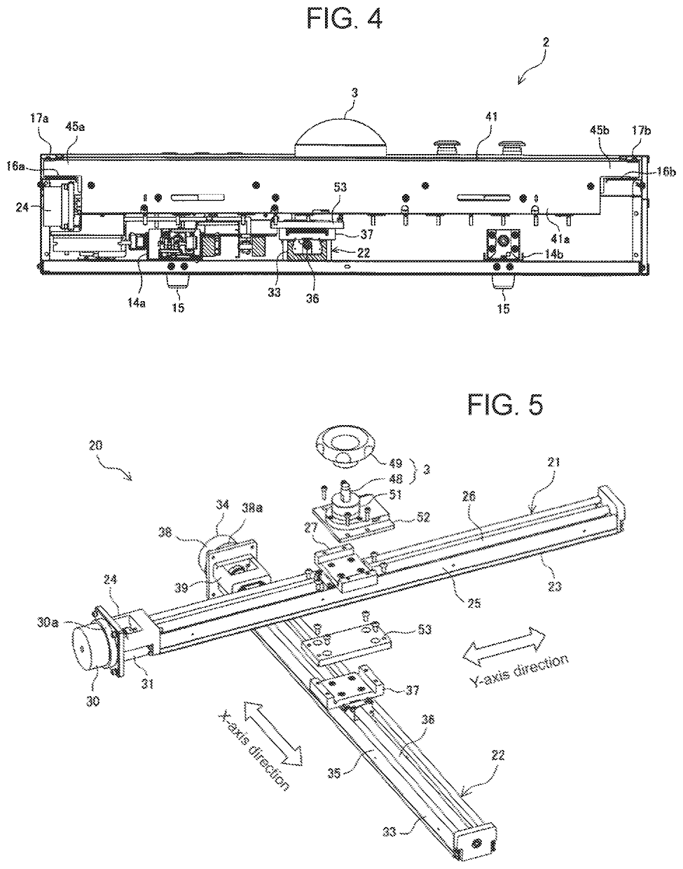

As shown in FIGS. 2 and 4, on the front and rear inner walls (front frame 6a, rear frame 6b) of the casing 6, step surfaces 16a, 16b having constant widths over substantially the entire length in the left-right direction are formed inward at height positions slightly lower than the upper ends thereof. The front and rear inner walls of the casing 6 are bent inward at right angles at the upper end parts thereof to form bent plate portions 17a, 17b having constant widths over substantially the entire length in the left-right direction, and gaps are defined between the bent plate portion 17a, 17b and the step surface 16a, 16b therebelow. The left and right side parts of the left cover 4a and the right cover 4b are inserted into the gaps over substantially the entire length in the front-rear direction. When the operation unit 3 moves in the left-right direction (X-axis direction), the gaps serve as guides for expanding and contracting the left cover 4a and the right cover 4b of the bellows structure in accordance with the movement. The same structure is adopted for the front cover 4c and the rear cover 4d, which will be described later.

### (3) Actuator Mechanism 20

As shown in FIG. 5, the actuator mechanism 20 includes a Y-axis direction actuator 21 for driving the operation unit 3 in the Y-axis direction (front-rear direction) and an X-axis direction actuator 22 for driving the operation unit 3 in the X-axis direction (left-right direction). That is, the actuator mechanism 20 is a two-axis linear motion actuator. As shown in FIG. 2, the actuator mechanism 20 is arranged on the front-rear reinforcement members 13a to 13c and the left-right reinforcement members 14a, 14b in the order of the X-axis direction actuator 22 and the Y-axis direction actuator 21.

### A) Y-Axis Direction Actuator 21

As shown in FIGS. 2 and 5, the Y-axis direction actuator 21 includes a guide portion 23 for guiding the operation unit 3 linearly in the Y-axis direction, and a Y-axis direction drive unit 24 for driving the operation unit 3 along the guide portion 23. The Y-axis direction drive unit 24 is provided integrally with the guide portion 23 at one end of the guide portion 23 (the end on the rear side as shown in FIGS. 2 and 4).

As shown in FIG. 5, the guide portion 23 is configured of a rectangular channel-like guide frame 25 which is opened upward, a rod-like feed screw 26 which extends in the longitudinal direction inside the guide frame 25, and a slider block 27. The upper surfaces of both side parts of the guide frame 25 along the longitudinal direction function as slider rails for guiding the slider block 27 in the longitudinal direction thereof. The slider block 27 includes a nut portion to be screwed into the screw groove of the feed screw 26 via balls formed of a plurality of steel balls, and is combined with the feed screw 26 to configure a ball screw structure.

As shown in FIGS. 4 and 5, the Y-axis direction drive unit 24 includes the Y-axis direction drive motor 30 capable of rotating in forward and reverse directions, and a reduction gear unit 31 interposed between a motor shaft of the Y-axis direction drive motor 30 and the feed screw 26. Further, a rotary encoder 30a for detecting the rotation direction and the rotation amount of the Y-axis direction drive motor 30 is attached to the motor shaft of the Y-axis direction drive motor 30. In the present embodiment, a DC servo motor is used as the Y-axis direction drive motor 30.

The reduction gear unit 31 is configured of a gear train which reduces the rotation speed of the Y-axis direction drive motor 30 and transmits the rotation to the feed screw 26. The reduction gear ratio of the reduction gear unit 31 is set to be capable of generating sufficient torque to transmit the drive force of the Y-axis direction drive motor 30 to the upper limb of the user U via the operation unit 3. Here, it is preferable that the reduction gear ratio of the reduction gear unit 31 is set relatively high so that the reduction gear unit 31 is not easily rotated by a reverse input from the feed screw 26 side when the driving of the Y-axis direction drive motor 30 is stopped. This also applies to the reduction gear ratio of a reduction gear unit 39 (configuring the X-axis actuator 22) described later.

As shown in FIG. 5, the Y-axis direction actuator 21 is attached on the X-axis direction actuator 22 via a coupling member 53. The coupling member 53 is formed of a rectangular plate-like member, is coupled to the lower surface of the guide frame 25, and fixes the guide portion 23 integrally on the slider block 37 of the X-axis direction actuator 22. The Y-axis direction actuator 21 travels right above the guide frame 35 configuring the X-axis direction actuator 22 along the longitudinal direction thereof when the operation unit 3 is moved in the X-axis direction.

### B) X-Axis Direction Actuator 22

As shown in FIGS. 2 and 5, the X-axis direction actuator 22 is configured similarly to the Y-axis direction actuator 21 described above in principle. That is, the X-axis direction actuator 22 has a guide portion 33 for guiding the Y-axis direction actuator 21 linearly in the X-axis direction, and an X-axis direction drive unit 34 for driving the Y-axis direction actuator 21 along the guide portion 33. The X-axis direction drive unit 34 is arranged integrally with the guide portion 33 at one end (the right end in FIGS. 2 and 3) of the guide portion 33.

As shown in FIG. 5, the guide portion 33 is configured of the rectangular channel-like guide frame 35 which is opened upward, the rod-like feed screw 36 which extends in the longitudinal direction inside the guide frame 35, and the slider block 37. The upper surfaces of both side parts of the guide frame 35 along the longitudinal direction function as slider rails for guiding the slider block 37 in the longitudinal direction thereof. The slider block 37 includes a nut portion to be screwed into the screw groove of the feed screw 36 via balls formed of a plurality of steel balls, and is combined with the feed screw 36 to configure a ball screw structure.

As shown in FIGS. 3 and 5, the X-axis direction drive unit 34 includes the X-axis direction drive motor 38 capable of rotating in forward and reverse directions, and the reduction gear unit 39 interposed between a motor shaft of the X-axis direction drive motor 38 and the feed screw 36. Further, the rotary encoder 38a for detecting the rotation direction and the rotation amount of the X-axis direction drive motor 38 is attached to the motor shaft of the X-axis direction drive motor 38. In the present embodiment, a DC servo motor is used as the X-axis direction drive motor 38.

The reduction gear unit 39 is configured of a gear train which reduces the rotation speed of the X-axis direction drive motor 38 and transmits the rotation to the feed screw 36. The reduction gear ratio of the reduction gear unit 39 is set to be capable of generating sufficient torque to transmit the drive force of the X-axis direction drive motor 38 to the upper limb of the user U via the Y-axis direction actuator 21 and the operation unit 3.

### (4) Movable Frame 41

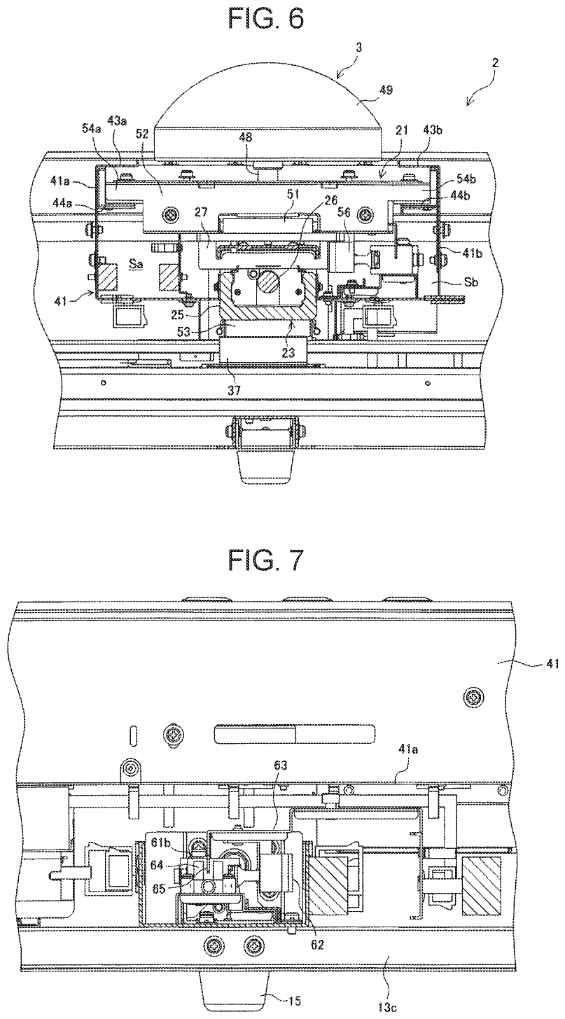

As shown in FIGS. 2 to 4, the Y-axis direction actuator 21 is integrated with a movable frame 41 extending over substantially the entire length in the Y-axis direction inside the casing 6. As shown in FIG. 6, the movable frame 41 is configured of a pair of movable frame members 41a, 41b each having a substantially L-shaped cross section and extending along the longitudinal direction of the guide portion 23. The movable frame members 41a, 41b are screw-fastened to both side parts along the longitudinal direction of the guide frame 25 with the inner side of the L-shape oriented toward the guide portion 23, respectively. Thus, between the guide portion 23 and the movable frame members 41a, 41b, there are defined a horizontal surface having a constant width extending laterally from the side surface of the guide frame 25, and groove-like spaces Sa, Sb each having a rectangular cross section.

Upper end parts of the movable frame members 41a, 41b fixed to the guide frame 25 are bent at right angles toward the inner side, that is, toward the guide frame 25 over the entire length in the longitudinal direction to configure bent plate portions 43a, 43b each having a constant narrow width. On the vertical inner surface of the L-shape of the movable frame members 41a, 41b, at a height position slightly lower than the upper ends thereof, projecting plate portions 44a, 44b each having a fixed narrow width extending perpendicularly from the inner surface to the guide frame 25 side are integrally formed over substantially the entire length excluding both end parts in the longitudinal direction. As a result, gaps are defined between the bent plate portions 43a, 43b and the projecting plate portions 43a, 43b, on the inner side of the upper end parts of the movable frame members 41a, 41b, over substantially the entire length excluding both end parts in the longitudinal direction. The front and rear side parts of the front cover 4c and the rear cover 4d are inserted into the gaps over substantially the entire length in the left-right direction. When the operation unit 3 moves in the front-rear direction (Y-axis direction), the gaps serve as guides for expanding and contracting the front cover 4c and the rear cover 4d of the bellows structure in accordance with the movement.

As shown in FIGS. 2 and 4, at both end parts of the movable frame member 41a, 41b in the longitudinal direction, parts below the projecting plate portion 44a, 44b are cut out, and the cut-out remaining parts configure projection portions 45a, 45b in the longitudinal direction. When the actuator mechanism 20 is accommodated in the casing 6, the projection portions 45a, 45b are inserted with a margin into the gaps defined by the bent plate portions 17a, 17b and the step surfaces 16a, 16b of the front and rear side inner walls (front frame 6a, rear frame 6b) of the casing 6.

### (5) Operation Unit 3

As shown in FIG. 5, the operation unit 3 is attached on the actuator mechanism 20. The operation unit 3 is configured of a relatively short vertical operation rod 48 and a handle member 49 arranged at an upper end thereof. The handle member 49 is formed in a relatively thick disk shape so that the user U can grasp with one hand. In the present embodiment, the handle member 49 is attached to be rotatable about the operation rod 48 so that the user U can grasp and rotate the handle member 49 with his/her hand. However, the handle member 49 may be fixed. The operation rod 48 is integrated with the force sensor 51 which detects a force acting on the operation rod 48 (a force acting on the handle member 49) at the lower end side thereof.

As shown in FIGS. 5 and 6, the operation unit 3 is attached to an attachment plate 52. The attachment plate 52 is formed of a rectangular plate-like member, and has a slightly smaller dimension than the inner width of the movable frame 41 in the width direction perpendicular to the longitudinal direction of the movable frame 41. Both side parts of the attachment plate 52 along the longitudinal direction of the movable frame 41 are cut off at a right angle on the lower surface side, and the cut-off remaining parts configure side parts 54a, 54b having dimensions smaller than a height dimension of the gaps defined by the bent plate portions 43a, 43b and the projecting plate portions 44a, 44b.

The attachment plate 52 is attached to the slider block 27 such that the side parts 54a, 54b are inserted with a margin into the gaps defined by the bent plate portions 43a, 43b and the projecting plate portions 44a, 44b and traverse the groove-like spaces Sa, Sb defined between the guide portion 23 and the movable frame members 41a, 41b.

### (6) Force Sensor 51

Various types of force sensors 51 each having a different detection principle are known, and in the present embodiment, a commercially available six-axis force sensor using a strain gauge is adopted as the force sensor 51. The strain gauge is attached to a strain body (not shown). The strain body is a member which deforms by receiving force and torque, and is an important member which affects the performance of the six-axis force sensor.

Generally, a six-axis force sensor is a sensor which indicates the magnitude and direction of the force and torque (moment) by a three-dimensional space vector, and detects the force F₀ (Fx, Fy, Fz) in an orthogonal X, Y, Z-axis direction and the torque T (Tx, Ty, Tz) acting around the three axes. The six-axis force sensor is also a useful sensor capable of obtaining contact information by calculation. A commercially available six-axis force sensor usually has a base portion on a fixed side and a sensing unit for receiving an external force to be detected.

In the present embodiment, the X-axis and the Y-axis of the six-axis force sensor are arranged so as to coincide with the X-axis direction and the Y-axis direction of the actuator mechanism 20, respectively. Further, as shown in FIG. 5, the force sensor 51 has a substantially short columnar base portion and a sensing unit arranged on the upper surface thereof. The operation rod 48 is vertically fixed to the center of the upper surface of the sensing unit of the force sensor 51. The base portion of the force sensor 51 is integrated with the slider block 27 of the Y-axis direction actuator 21 via the attachment plate 52.

The force sensor 51 is configured to be capable of detecting, as (Fx, Fy, Fz, Tx, Ty, Tz), the force F₀ directly received by the operation rod 48 from the upper limb of the user U and the torque T acting around the respective axes when the upper limb of the user U moves the operation unit 3 or is moved by the operation unit 3. In the present embodiment, as will be described later, the force sensor 51 is used only for detecting the force Fx in the X-axis direction and the force Fy in the Y-axis direction acting on the operation unit 3 (strictly, the vector component Fx in the X-axis direction and the vector component Fy in the Y-axis direction of the force F₀ acting on the operation unit 3), that is, (Fx, Fy).

### (7) Limit Sensor 55a, 55b, 61a, 61b

As shown in FIG. 2, the motion training apparatus 1 includes a pair of limit sensors 55a, 55b in order to limit the movable range of the operation unit 3 in the Y-axis direction due to the Y-axis direction actuator 21. The limit sensors 55a, 55b are arranged, on a horizontal plane between the guide portion 23 and one movable frame member 41b (the right side in FIG. 2), at the inner sides of the front and rear side inner walls of the casing 6, respectively.

The limit sensors 55a, 55b adopt a known structure in which an arm lever is spring-biased so as to be horizontally rotatable. As shown in FIG. 6, an operation block 56 for rotating the arm levers of the limit sensors 55a, 55b is arranged in a protruding manner on the lower surface of the attachment plate 52. When the operation unit 3 moves in the Y-axis direction and the operation block 56 rotates the arm levers, the limit sensors 55a, 55b are turned on.

Further, as shown in FIG. 2, the motion training apparatus 1 includes a pair of limit sensors 61a, 61b in order to limit the movable range of the Y-axis direction actuator 21 due to the X-axis direction actuator 22 in the X-axis direction. The limit sensors 61a, 61b are arranged, on the left-right reinforcement member at the rear side, at the inner sides of the left and right side inner walls of the casing 6, respectively.

The limit sensors 61a, 61b also have a known structure in which an arm lever is spring-biased so as to be horizontally rotatable. As shown in FIG. 7, an operation block 62 for rotating the arm levers of the limit sensors 61a, 61b is arranged in a protruding manner, via an attachment plate 63, on the lower surface of one movable frame member 41a (the left side in FIG. 2). When the operation unit 3 moves in the X-axis direction together with the Y-axis direction actuator 21 and the operation block 62 rotates the arm levers, the limit sensors 61a, 61b are turned on.

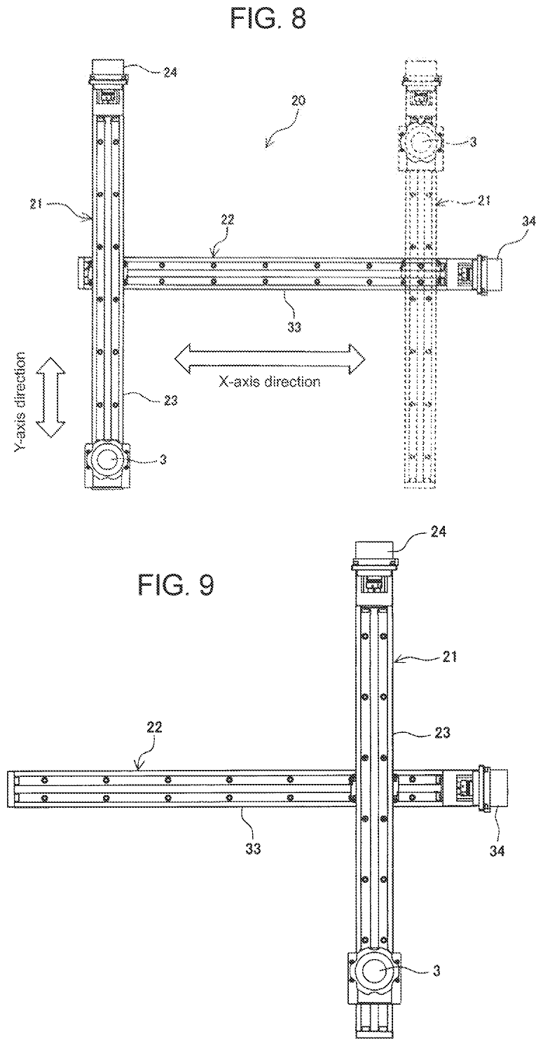

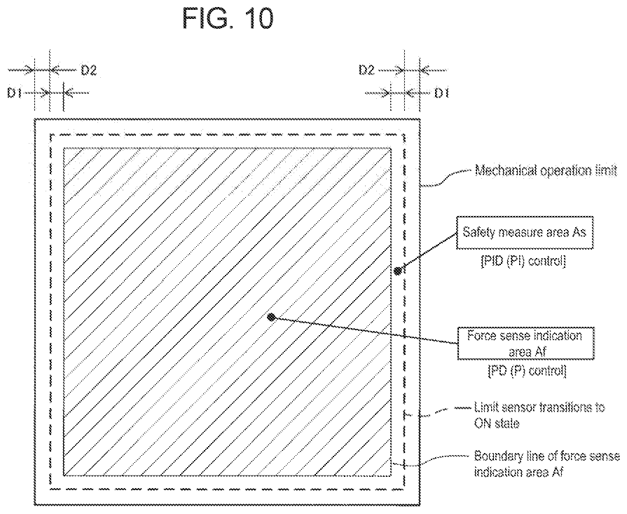

FIG. 8 shows the movable range of the operation unit 3 in the X-axis direction and the Y-axis direction in the actuator mechanism 20. Further, FIG. 10 shows the relationship between the movable range of the operation unit 3 in the XY plane and the limit sensors 55a, 55b, 61a, 61b.

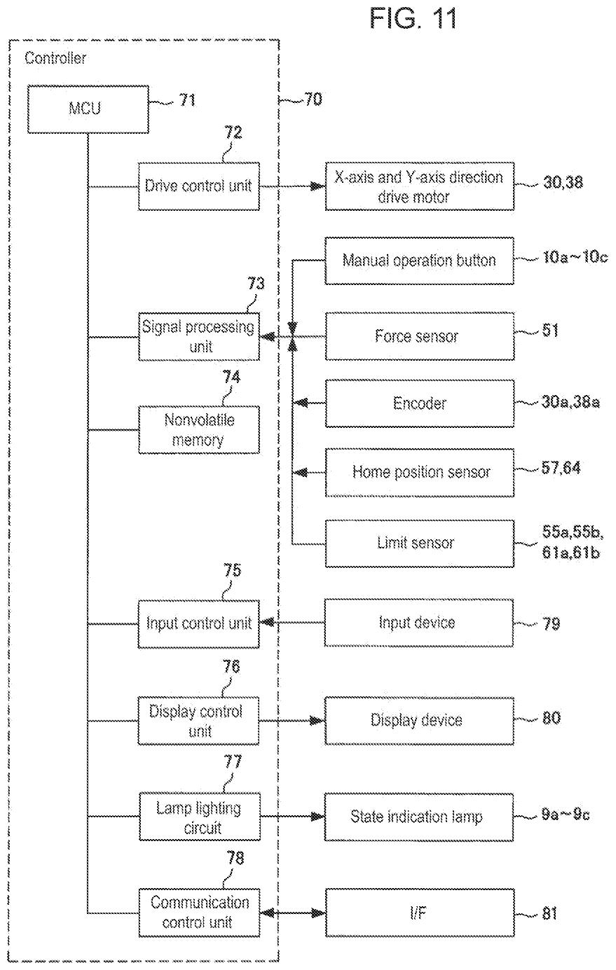

The broken line shown in FIG. 10 indicates the positions where the limit sensors 55a, 55b, 61a, 61b detect the operation blocks 56, 62 and the limit sensors 55a, 55b, 61a, 61b transition to the ON state. An area indicated by oblique lines is arranged as being distanced inward by a predetermined distance (D1 to be described later) from the position of the broken line. The area including the central part in the XY plane in which the operation unit 3 is movable as being represented by the oblique lines is an area in which the motion training of the user U can be performed, and in the present embodiment, the area also corresponds to an area in which a display device 80 (see FIG. 11) can display (indicate) a trajectory and a load variation of the operation unit 3 during or after the motion training of the user U, and therefore, the area is hereinafter referred to as a force sense indication area Af.

The arm levers of the limit sensors 55a, 55b, 61a, 61b are configured to be still rotatable after the limit sensors 55a, 55b, 61a, 61b transition to the ON state, and the rotation limit of the arm levers is the mechanical operation limit of the X-axis and Y-axis direction actuators 22, 21. When the position of the mechanical operation limit is represented on the XY plane, the outer frame of FIG. 10 is obtained. Hereinafter, an area outside the force sense indication area Af and inside the outer frame of FIG. 10 will be referred to as a safety measure area As.

In the present embodiment, the dimension between the positions at which the limit sensors 55a, 55b, 61a, 61b transition to the ON state is set to 540 [mm] (X-axis direction)×550 [mm] (Y-axis direction). Further, the distance D1 from the position where the limit sensors 55a, 55b, 61a, 61b transition to the ON state to the boundary line of the force sense indication area Af is set to 30 [mm] in both the X-axis and Y-axis directions, and the distance D2 from the position where the limit sensors 55a, 55b, 61a, 61b transition to the ON state to the mechanical operation limit of the X-axis and Y-axis direction actuators 22, 21 is set to 20 [mm] in both the X-axis and Y-axis directions. Therefore, the dimension of the force sense indication area Af is set to 510 [mm] (X-axis direction)×520 [mm] (Y-axis direction).

### (8) Home Position Sensor 57, 64

As shown in FIG. 2, the motion training apparatus 1 includes a home position sensor 64 for setting the initial position of the operation unit 3 in the X-axis direction. The home position sensor 64 is arranged on the left-right reinforcement member 14a on the rear side of the casing 6 and closer to the center than the limit sensor 61b. As shown in FIG. 7, on the lower surface of the movable frame member 41a, a plate-like sensor flag member 65 protruding vertically downward is attached to the attachment plate 63 so as to be capable of passing through a gap between a light emitting unit and a light receiving unit of the home position sensor 64 when the operation unit 3 is moved in the X-axis direction.

Further, as shown in FIG. 2, the motion training apparatus 1 has a home position sensor 57 for setting the initial position of the operation unit 3 in the Y-axis direction. The home position sensor 57 is arranged on the horizontal surface between the movable frame members 41a, 41b on the rear side with respect to the limit sensor 55a. Similarly to the sensor flag member 65 of the X-axis direction, a plate-like sensor flag member (not shown) protruding vertically downward is attached to the attachment plate 52 so as to be capable of passing through a gap between a light emitting unit and a light receiving unit of the home position sensor 57 when the operation unit 3 is moved in the Y-axis direction.

Each of the home position sensors 64, 57 is a transmission-integrated sensor including a light emitting unit and a light receiving unit which are arranged to face each other with a small gap therebetween, and in the present embodiment, a sensor which turns on when light enters the light receiving unit and turns off when the light receiving portion is shielded is used.

FIG. 9 shows a state in which the operation unit 3 is positioned at the home position. As shown in FIG. 9, the home position of the operation unit 3 is set to be closer to the front side in the Y-axis direction and closer to the right side in the X-axis direction with respect to the intersecting center position of the X-axis and Y-axis direction actuators 22, 21. Therefore, when the user U is positioned in front of the motion training apparatus 1 as shown in FIG. 1, the user U can immediately touch the handle member 49 of the operation unit 3 by extending the right hand HR forward.

### (9) Electric System

The motion training apparatus 1 further includes, in the casing 6, a controller 70 (see FIG. 11) which controls the motion training apparatus 1, and a power supply unit (not shown) which converts commercial AC power into DC power for driving/operating the above-described mechanism section and the controller 70.

### 1.2. Controller

### 1.2.1. Overview of Controller

As shown in FIG. 11, the controller 70 includes an MCU 71 configured by a CPU for performing high-speed calculation, a ROM for storing a basic control program and program data, a RAM for temporarily storing various data as well as serving as a work area for the CPU, and an internal bus which connects the above.

The internal bus of the MCU 71 is connected to an external bus. The external bus is connected to a drive control unit 72 for controlling driving of the X-axis and Y-axis direction drive motors 38, 30, a signal processing unit 73 for processing signals from the sensors described above, a nonvolatile memory 74 such as a large-capacity flash memory and a hard disk, an input control unit 75 for controlling information input from an input device 79 such as a mouse and a keyboard, a display control unit 76 for controlling display (drawing) to the display device 80 such as a display, a lamp lighting circuit 77 for lighting state indication lamps 9a to 9c, and a communication control unit 78 for controlling communication with an external apparatus such as a notebook computer via an interface (I/F) 81.

### 1.2.2. Detail of Controller

### (1) Drive Control Unit 72

The drive control unit 72 includes an X-axis direction motor driver for controlling driving of the X-axis direction drive motor 38, and a Y-axis direction motor driver for controlling driving of the Y-axis direction drive motor 30. The X-axis and Y-axis direction motors 38, 30 each have a control IC (not shown). Each control IC controls the power supplied to the X-axis or Y-axis direction drive motor 38, 30 (see also FIG. 13B) in accordance with a current value (output current Ii, duty) instructed by the MCU 71.

### (2) Signal Processing Unit 73

The signal processing unit 73 processes the signal output from the force sensor 51 with the signal processing IC (not shown) and outputs the processed signal to the MCU 71. That is, the signal of the strain gauge arranged in the six-axis force sensor is converted into a voltage (change) signal by a bridge circuit, high-frequency noise is removed by a low-pass filter (LPF), and then, a weak signal is amplified by an amplifier circuit such as an operational amplifier. Next, the amplified signal is converted into a digital value by an A/D converter, and the components (Fx, Fy, Fz, Tx, Ty, Tz) of the force and torque are calculated by performing the strain-load conversion matrix operation with the signal processing IC.

However, in the present embodiment, since the MCU 71 uses only the force Fx in the X-axis direction and the force Fy in the Y-axis direction acting on the operation unit 3, the signal processing unit 73 outputs the calculated value of (Fx, Fy) to the MCU 71. In the present embodiment, since the sampling rate of the A/D converter described above is set to 10 [ms], the signal processing unit 73 outputs the value of (Fx, Fy) to the MCU 71 every 10 [ms].

Further, the signal processing unit 73 outputs a count value obtained by counting the number of pulses output from the encoders 30a, 38a and a default value of the rotation direction (e.g., 0 when the X-axis or Y-axis direction drive motor 38, 30 rotates forward and 1 when it rotates backward) to the MCU 71.

Further, the signal processing unit 73 outputs, to the MCU 71, whether the home position sensors 57, 64 are turned on (whether or not the home position has been detected) and a default value representing whether or not the limit sensors 55a, 55b, 61a, 61b are turned on (e.g., a default value of F₀ in the OFF state and a default value of 1 when in the ON state).

Furthermore, the signal processing unit 73 monitors whether or not the manual operation buttons 10a to 10c are pressed (referring to whether or not the output of each of the switching elements which detects pressing of corresponding one of the manual operation buttons 10a to 10c becomes a high level), and outputs a default value (e.g., a default value when the switch is in the OFF state is 0 and a default value when the switch is in the ON state is 1) to the MCU 71. Here, a protective resistor is inserted between the output side of each switching element and the input side of the signal processing IC in order to prevent damage to the signal processing IC.

In the present embodiment, since the value of (Fx, Fy) of the force sensor 51 is output to the MCU 71 every 10 [ms], the above signal information is output to the MCU 71 in accordance with this cycle. That is, the signal processing unit 73 outputs, to the MCU 71 every 10 [ms], the signal information represented by, for example, (Fx, Fy, the count value of the encoder 38a, the default value of the rotation direction of the X-axis direction drive motor 38, the count value of the encoder 30a, the default value of the rotation direction of the Y-axis direction drive motor 30, the default value of the state of the home position sensor 57, the default value of the state of the home position sensor 64, the default value of the state of the limit sensor 55a, the default value of the state of the limit sensor 55b, the default value of the state of the limit sensor 61a, the default value of the state of the limit sensor 61b, the default value of the state of the emergency stop button 10a, the default value of the state of the pause button 10b, the default value of the state of the initialization button 10c).

Here, when the default values of the states of the emergency stop button 10a or the pause button 10b indicates that the emergency stop button 10a or the pause button 10b is depressed, the MCU 71 performs control so as to stop driving of the X-axis and Y-axis direction drive motors 38, 30 via the drive control unit 72. This also applies to the case in which the default value indicates that the default value of any of the limit sensors 55a, 55b, 61a, 61b is transitioned to the ON state. When the emergency stop button 10a is depressed and when the limit sensor 55a, 55b, 61a, 61b is transitioned to the ON state, the MCU 71 immediately terminates a trajectory setting routine, a load detecting routine, and a motion training routine, which will be described later.

Further, when the default value representing the state of the initialization button 10c indicates that the initialization button 10c is depressed, the MCU 71 drives the X-axis and Y-axis direction drive motors 38, 30 at a preset speed via the drive control unit 72 in order to position the operation unit 3 at the home position, and when the default value of the home position sensor 57 and the default value of the home position sensor 64 output from the signal processing unit 73 become a default value representing that they are positioned respectively at the home positions, driving of the X-axis and Y-axis direction drive motors 38, 30 are individually stopped.

### (3) Lamp Lighting Circuit 77

The lamp lighting circuit 77 includes three lighting circuits for lighting a green LED 9a, a white LED 9b, and a red LED9c. Each lighting circuit includes a switching element such as a MOSFET, and is turned on when the MCU 71 outputs a digital signal (high-level signal) to the gate of the switching element, thereby individually lighting the green LED 9a, the white LED 9b, and the red LED 9c. Here, a protective resistor is inserted between the gate of each switching element and the MCU 71 in order to prevent damage to the MCU 71.

### (4) Other

As the nonvolatile memory 74, the input control unit 75, the display control unit 76, and the communication control unit 78, known ones can be used. Here, the nonvolatile memory 74 stores personal data of the user U and data related to motion training such as motion training history. Since the processing cycle (10 [ms]) of the MCU 71 is different from the vertical blanking cycle of the display device 80, the display control unit 76 determines whether or not a vertical blanking interrupt (Vsync) performed once in 1/60 [s] (16.6 [ms]) coinciding with the vertical blanking cycle has been performed, adds drawing information instructed from the MCU 71 when negative determination is made, and outputs current drawing information to the display device 80 when positive determination is made.

### 2. Operation

Next, operation of the motion training apparatus 1 of the present embodiment will be described.

### 2.1. Overview of Operation Control

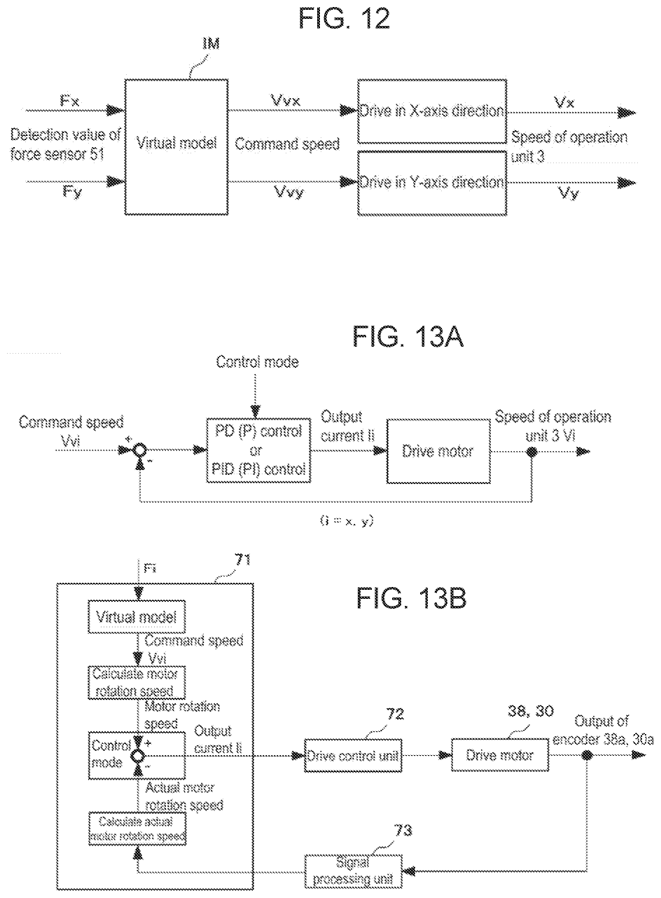

As shown in FIG. 12, in an active training mode to be described later, the MCU 71 calculates a speed vᵥₓ in the X-axis direction and a speed v_{vy} in the Y-axis direction to be generated for the operation unit 3 via a virtual model IM simulating static friction in the planar motion from the force Fx in the X-axis direction and the force Fy in the Y-axis direction acting on the operation unit 3 output from the signal processing unit 73, and outputs the calculated speed to the drive control unit 72.

The virtual model IM is represented by the following equations.

$$[ Expression 1 ]$$

$$\begin{matrix}{m}_{v} {\dot{v}}_{vi} = \{ \begin{matrix}- {c}_{v} , {v}_{vi} , ( {F}_{o}^{2} \leq {μ}_{s}^{2} and {v}_{v}^{2} \leq {v}_{vst}^{2} ) \\ - {c}_{v} {v}_{vi} - {μ}_{k} {μ}_{i} + {F}_{i} , ( else ) \end{matrix} , ( i = x , y ) \\ Here , & ( 1 ) \\ {F}_{o}^{2} = {F}_{x}^{2} + {F}_{y}^{2} , & ( 2 ) \\ {v}_{v}^{2} = {v}_{vx}^{2} + {v}_{vy}^{2} , & ( 3 ) \\ {u}_{i} = \{ \begin{matrix}sgn ( {v}_{vi} ) , ( {v}_{vi}^{2} \geq {v}_{v}^{2} ) , \\ {v}_{vi} \text{/} {v}_{v} , ( else ) \end{matrix} & ( 4 )\end{matrix}$$

The upper part of Equation (1) shows a stationary state of the operation unit 3, and the lower part shows an operating state. Here, mᵥ is the virtual mass of the operation unit 3, vᵥᵢ is the speed of the operation unit 3, cᵥ is the viscous damping coefficient, μₖ is the friction coefficient, F₀ is the resultant force of (Fx, Fy), μₛ is the maximum static friction force, and vᵥₛₜ is the speed in which the operation unit 3 is considered to be stationary and is given as vᵥₛₜ<<1. Further, uᵢ is the component speed in each axial direction when the speed of the operation unit 3 is normalized to 1, and (uₓ²+u_{y}²) is 1. Equation (4) is for preventing the dynamic frictional force from becoming excessively large due to, for example, the effect of noise on the force sensor 51 and calculation error of the MCU 71.

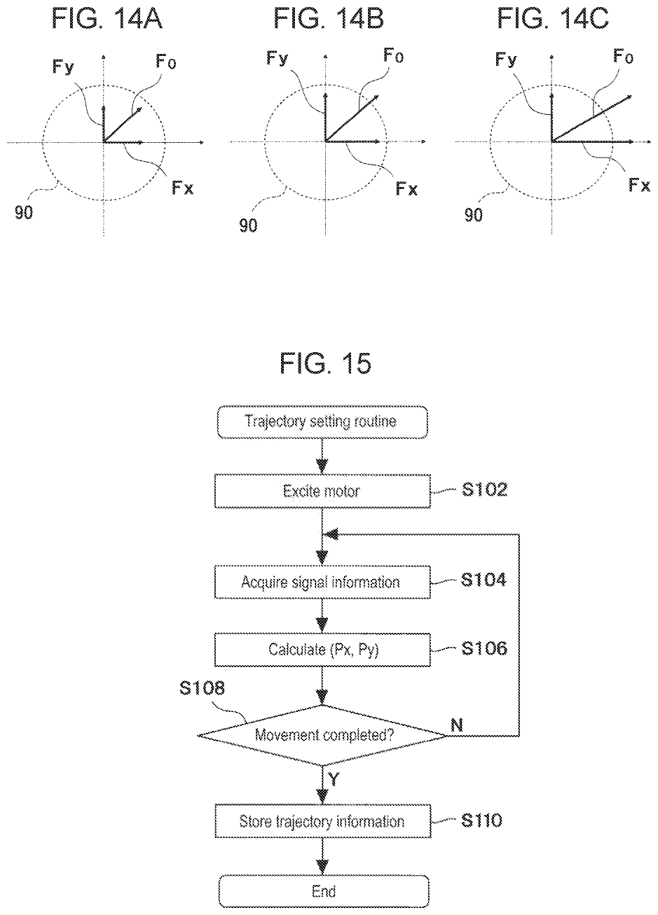

The upper part of Equation (1) is a calculation formula of the speed (vᵥₓ, v_{vy}) of the operation unit 3 when the resultant force F₀ is within a circular static friction area 90 for reproducing the static friction, as shown in FIG. 14A, and the lower part is a calculation formula of the speed (vᵥₓ, v_{vy}) of the operation unit 3 when the resultant force F₀ is outside the static friction area 90, as shown in FIGS. 14B and 14C. The size of the static friction area 90 is determined by the values of μₛ and vᵥₛₜ according to the upper part of Equation (1). Since the values of μₛ and vᵥₛₜ can be determined by the magnitude of the speed (command speed) to be generated for the operation unit 3, the value of the radius of the static friction area 90 can be set to an arbitrary value.

The forces (Fx, Fy) in the X-axis and Y-axis directions detected by the force sensor 51 are detected as component forces of the force to be generated for the operation unit 3 by the drive forces of the X-axis and Y-axis direction drive motors 38, 30.

As shown in FIG. 13A, the speed (vᵥₓ, v_{vy}) of the operation unit 3 calculated using the virtual model IM is set as the command speed, and the drive control unit 72 realizes the virtual motion environment by causing the actual speed (vₓ, v_{y}) of the operation unit 3 to follow the command speed. Specific control by the MCU 71 will be described later.

Here, since the DC servo motor is used as each of the X-axis and Y-axis direction drive motors 38, 30, the control mode of the drive control unit 72 (motor driver) is set to PID control, and thus it is possible to follow the command speed with high accuracy. However, it has been confirmed that, when the virtual mass mᵥ is reduced and the training load is set to be small, the response delay due to the integration operation of PID control has an influence and the operation unit 3 becomes vibratory during the operation. Therefore, in the force sense indication area Af, the control mode is set to PD control excluding an integral term for calculating an output (current value) proportional to an integral value of the deviation from PID control (or P control further excluding a differential term for calculating an output proportional to a differential value of the deviation), and the proportional gain (Kp) is set high. Thus, responsiveness is improved although steady-state deviation occurs, and vibration of the operation unit 3 during operation is suppressed.

On the other hand, if the stationary-state deviation is large with respect to the command speed (vᵥₓ, v_{vy}), the positional accuracy of the operation unit 3 with respect to the mechanical operation limit (see FIG. 10) decreases, so that the operation unit 3 may collide with the mechanical operation limit of the motion training apparatus 1 and impact may be caused at the user U or the motion training apparatus 1. In this case, it is also conceivable to provide a filter or the like to suppress the vibration of the operation unit 3. However, similarly to the above, the response delay affects and the position accuracy decreases. In order to obviate such an impact, it is necessary to take a large margin in setting the boundary line of the force sense indication area Af of the operation unit 3 with respect to the mechanical operation limit. However, as a result, the force sense indication area Af becomes extremely small. Therefore, PID (or PI) control is performed in the area where the position accuracy is to be emphasized (safety measure area As described above).

### 2.2. Detail of Operation

Next, operation of the motion training apparatus 1 of the present embodiment will be described mainly on the CPU of the MCU 71 (hereinafter referred to as the CPU).

When the user U performs motion training using the motion training apparatus 1, (1) the trajectory setting mode is performed, (2) the load detection mode is performed, and then, (3) the motion training mode is performed. In the trajectory setting mode, the user U grasps the operation unit 3, and a training instructor holds the hand of the user U and moves the operation unit 3 within the operation range in accordance with the upper limb conditions of the user U, thereby setting the trajectory which the operation unit 3 follows. In the load detection mode, only the user U grasps the operation unit 3 and follows the trajectory set in the trajectory setting mode, and the position (trajectory) of the operation unit 3 due to the user U and the load received concurrently by the operation unit 3 are detected. In the following description, it is assumed that the initialization button 10c is depressed and the operation unit 3 is positioned at the home position before the control is performed by the CPU in each mode.

### (1) Trajectory Setting Mode

In the trajectory setting mode, the CPU executes a trajectory setting routine shown in FIG. 15. In the trajectory setting routine, first, in step (hereinafter abbreviated as S) 102, the X-axis and Y-axis drive motors 38, 30 are excited via the drive control unit 72. Since the operation unit 3 is connected to the X-axis and Y-axis drive motors 38, 30 respectively via the reduction gear units 39, 31, a predetermined load is applied to the user U when the user U moves the operation unit 3 under the initiative of the training instructor. The entire trajectory (reference trajectory) which the user U plans to follow under the initiative of the training instructor may be displayed on the display device 80 in advance before S102 or S104 described below.

Next, the signal information described above is acquired in S104, and the position (Px, Py) of the operation unit 3 is calculated in S106. That is, the CPU calculates the position Px of the operation unit 3 in the X-axis direction by integrating the count value of the encoder 38a included in the signal information with the count integrated value of one cycle (10 [ms]) before, and similarly calculates the position Py of the operation unit 3 in the Y-axis direction by integrating the count value of the encoder 30a included in the signal information with the count integrated value of one cycle before. At this time, it is determined whether to add or subtract the count value with reference to the default values of the rotation direction of the X-axis and Y-axis direction drive motors 38, 30 included in the signal information.

Next, in S108, it is determined whether or not the movement of the operation unit 3 is completed. That is, it is determined whether or not the position (Px, Py) of the operation unit 3 is substantially the same for a preset set time (e.g., 1.5 [s]), and when negative determination is made, the process returns to S104 for detecting the subsequent (10 [ms] later) position of the operation unit 3, and when positive determination is made, the process proceeds to S110. Thus, the CPU calculates the position (Px, Py) of the operation unit 3 every 10 [ms].

In S110, the position (Px, Py) of the operation unit 3 calculated every 10 [ms] is stored in the nonvolatile memory 74 as trajectory information I₁ arranged in chronological order, and the trajectory setting routine is terminated. At this time, the CPU deletes the data at the position (Px, Py) of the operation unit 3 of the set time described in S108 and stores it in the nonvolatile memory 74.

### (2) Load Detection Mode

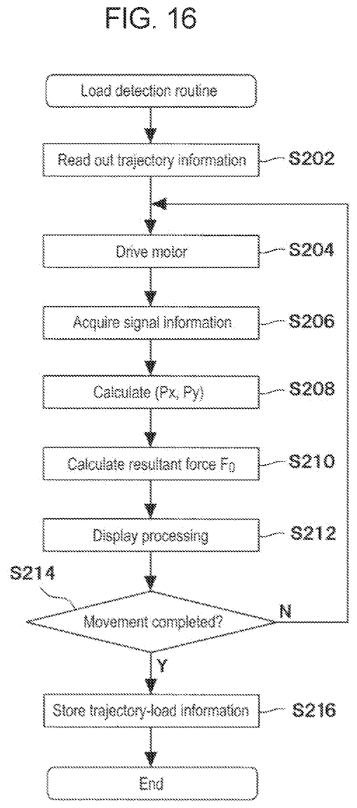

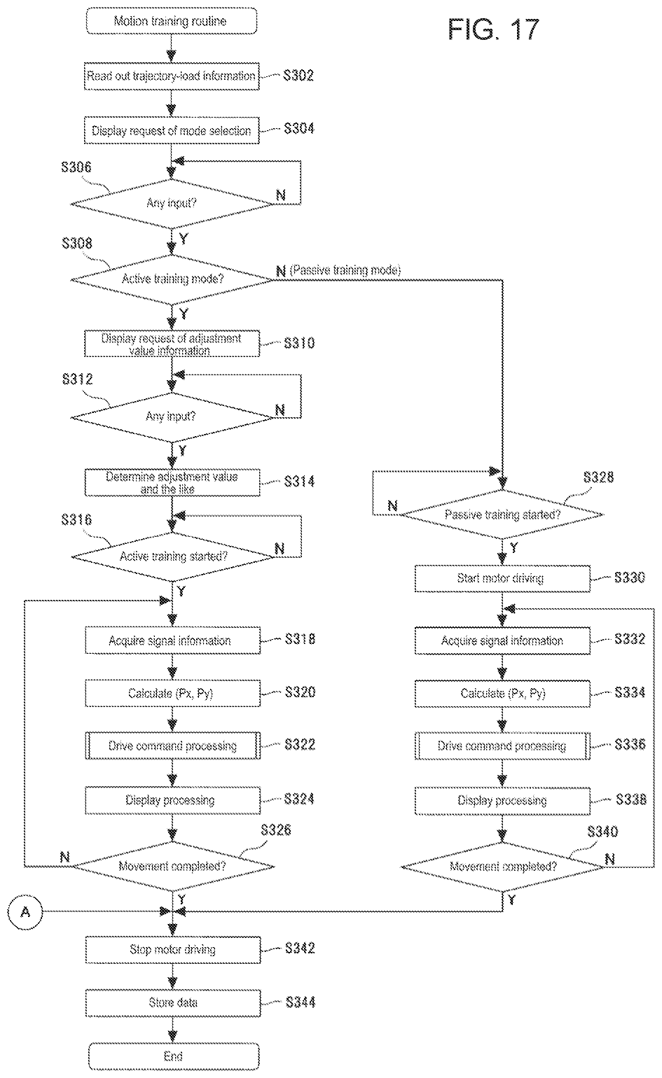

In the load detection mode, the CPU executes a load detection routine shown in FIG. 16. In the load detection routine, the trajectory information I₁ stored in the nonvolatile memory 74 is read out in S202, and the X-axis and Y-axis direction drive motors 38, 30 are driven via the drive control unit 72 so that the operation unit 3 reaches the position of the trajectory information I₁ (so that the operation unit 3 moves and reproduces the trajectory set in the trajectory setting mode) in the subsequent S204. That is, the command speed is obtained by dividing the distance in each of the X-axis direction and the Y-axis direction between the present position of the processing target of the trajectory information I₁ and the subsequent position of the trajectory information I₁ by the movement time 10 [ms] therebetween, and the command speed is output to the drive control unit 72.

Next, in S208, the signal information is acquired in S206, and the count values of the encoders 38a, 30a included in the signal information are integrated to calculate the position (Px, Py) of the operation unit 3. Next, in S210, the resultant force F₀ is calculated by combining the forces (Fx, Fy) acting on the operation unit 3 in the X-axis and Y-axis directions, which are included in the signal information (see also FIG. 14 and Equation (2)). Next, in S212, the position (Px, Py) of the operation unit 3 calculated in S208 and the resultant force F₀ (load) calculated in S210 are output to the display control unit 76 to display the position and the load of the operation unit 3 on the display device 80. At this time, the display control unit 76 generates image information obtained by adding the current (latest) drawing information to the image information of one cycle before, and performs parallel movement processing based on a predetermined origin position on the image display.

Next, in S214, it is determined whether or not the movement of the operation unit 3 has been completed by determining whether or not the processing of positioning the operation unit 3 at the last position of the trajectory information I₁ read in S202 has been performed. When negative determination is made, the process returns to S204 to continue load detection, and when positive determination is made, the process proceeds to S216. In S216, the data of the position (Px, Py) of the operation unit 3 and the data of the forces (Fx, Fy, F₀) acting on the operation unit 3 calculated every 10 [ms] are stored in the nonvolatile memory 74 as trajectory-load information I₂ (Px, Py, Fx, Fy, F₀) arranged in chronological order, and the load detection routine is terminated.

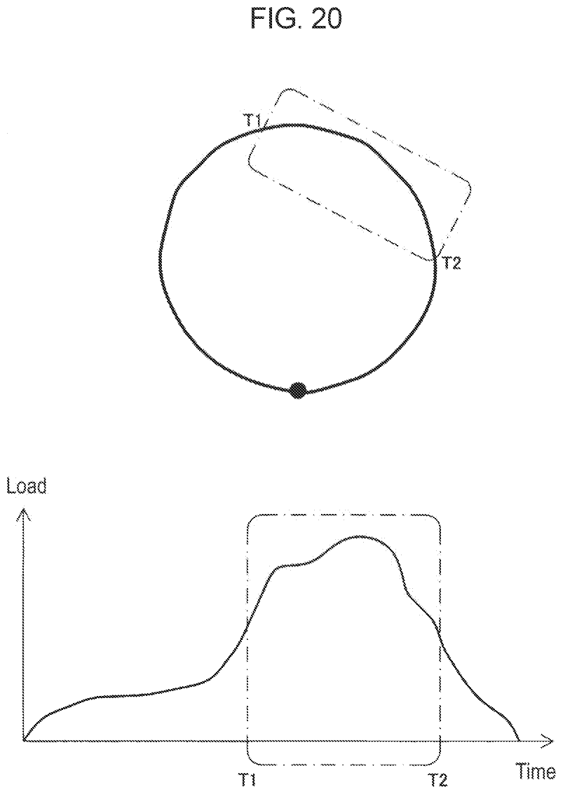

FIG. 20 schematically shows a screen displayed on the display device 80 at the time of positive determination in S214 (indicating the resultant force F₀ (load) as an absolute value |F₀|), in which the trajectory followed by the user U moving the operation unit 3 is displayed at the upper part of the screen, and the load variation at each position of the trajectory taking the time axis as the horizontal axis is displayed at the lower part. In the example of FIG. 20, it is shown that a large force is applied from the user U to the operation unit 3 in the range from time T1 to time T2. The display control unit 76 may control the display device 80 so as to, for example, change the color of the display in this range after positive determination is made in S214 in accordance with an instruction from the CPU (threshold information output from the CPU). Alternatively, as shown in FIG. 20, it may be emphasized by being surrounded by a chain line. Referring to the trajectory in the range from the time T1 to the time T2, it can be estimated that the user U could not successfully operate the operation unit 3, and the motion trainee can create the motion training program for the user U with reference to this data.

### (3) Motion Training Mode

In the motion training mode, the CPU executes a motion training routine shown in FIG. 17. The motion training mode includes an active training mode in which the user U moves the operation unit 3 so as to follow the trajectory of the trajectory-load information I₂ by himself/herself, and a passive training mode in which the user U moves while being pulled by the operation unit 3 which automatically follows the trajectory of the trajectory-load information I₂. The passive training mode is assumed to be a motion training mode mainly targeting a person under rehabilitation, and the active training mode is assumed to be a motion training mode targeting a person in the final stage of rehabilitation or a healthy person. The motion training apparatus 1 is set to have maximum values of Fx and Fy of 90 [N], maximum acceleration of 8 [m/s²], and maximum speed of 1.24 [m/s] so as to be available for motion training of a healthy person.

In the motion training routine, first, in S302, the trajectory-load information I₂ stored in the nonvolatile memory 74 is read out. Next, in S304, a screen for inquiring whether the active training mode or the passive training mode is selected is displayed on the display device 80, and the process waits until any selection (input) is made in S306 (negative determination in S306). When a selection is made (positive determination in S306), it is determined whether or not the active training mode is selected in following S308, and when positive determination is made, the process proceeds to S310, and when negative determination is made, the process proceeds to S328.

In S310, a screen for requesting adjustment value information is displayed on the display device 80. Each adjustment value is the parameter (the virtual mass mᵥ, the viscous damping coefficient cᵥ, the friction coefficient μₖ, the maximum static friction force μₛ, the speed vᵥₛₜ in which the operation unit 3 is considered to be stationary) of Equation (1) representing the virtual model IM described above. In the present embodiment, parameter inputting is facilitated by displaying on the display device 80, for example, a screen in which an explanation (e.g., motion amount: large, static friction force: medium) is added to several selectors determined in advance according to the magnitude of the momentum and the static friction force, or by displaying a level meter representing the magnitude of the motion amount and static friction force in an adjustable manner.

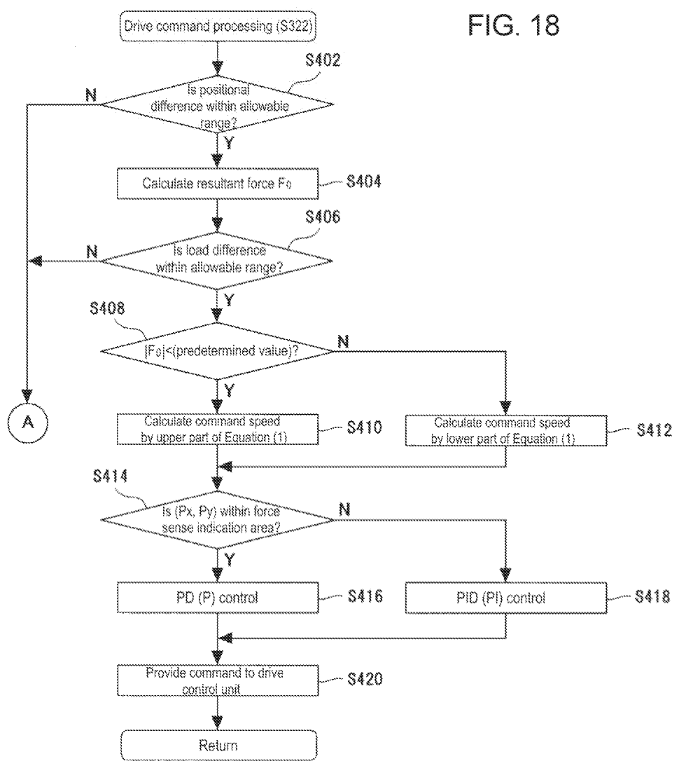

Next, in S312, the process waits (negative determination in S312) until there is an input of adjustment value information. When there is an input (positive determination in S312), the adjustment value information is acquired in following S314 to determine the value of the above-described parameters, and the value of the radius of the static friction area 90 shown in FIG. 14 (a predetermined value to be described later, see S408 of FIG. 18 as well) is determined from the determined values of μₛ and vᵥₛₜ.

Then, in S316, by determining whether or not the forces (Fx, Fy) are applied to the operation unit 3 by monitoring the signal information described above and whether or not the position of the operation unit 3 is moved from the home position, it is determined whether or not active training has started. Here, before the start of the active training (when negative in any determination in S316), the X-axis and Y-axis direction drive motors 38, 30 are in an excited state, and the operation unit 3 is positioned at the home position (0, 0).

When the active training is started (when positive in both determination in S316), the signal information is acquired in S318, and the count values of the encoders 38a, 30a included in the signal information are integrated to calculate the position (Px, Py) of the operation unit 3 in S320. Further, in S320, the actual speed (vₓ, v_{y}) of the operation unit 3 is calculated from the count values of the encoders 38a, 30a included in the signal information, that is, the rotation speed of the X-axis and Y-axis direction drive motors 38, 30 (and the reduction gear ratios of the reduction gear units 39, 31).

Next, in S322, drive command processing for giving a command (output current Ii) to the drive control unit 72 is executed. FIG. 18 is a flowchart of the drive command processing subroutine showing the details of the drive command processing of S322. In the drive command processing subroutine, in S402, it is determined whether or not the positional difference (distance difference) between the trajectory position of the trajectory-load information I₂ and the position (Px, Py) calculated in S320 is within a predetermined allowable range. When negative determination is made, it is regarded that the movement range of the upper limb of the user U is excessively widened, so that the drive command processing subroutine is terminated, and the process proceeds to S342 of FIG. 17. When positive determination is made, the process proceeds to S404.

In S404, the resultant force F₀ is calculated by combining the forces (Fx, Fy) acting on the operation unit 3 included in the signal information. In following S406, it is determined whether or not the difference (load difference) between the magnitude (absolute value) |F₀| of the resultant force F₀ and the magnitude |F₀| of the resultant force F₀ at a position of the operation unit 3 in the trajectory-load information I₂ closest to the position (Px, Py) of the operation unit 3 calculated in S320 is within a predetermined allowable range. When negative determination is made, it is regarded that the user U is excessively burdened more than expected, so that the drive command processing subroutine is terminated and the process proceeds to S342 of FIG. 17. When positive determination is made, the process proceeds to S408.

In S408, to determine whether or not the resultant force F₀ is within the static friction area 90 shown in FIG. 14, it is determined whether or not the magnitude |F₀| of the resultant force F₀ is equal to or smaller than the predetermined value (the value of the radius of the static friction area 90 calculated in S314 of FIG. 17). When positive determination is made, the command speed (vᵥₓ, v_{vy}) is calculated by the upper part of Equation (1) in S410 and the process proceeds to S414. When negative determination is made, the command speed (vᵥₓ, v_{vy}) is calculated by the lower part of Equation (1) in S412 and the process proceeds to S414. It should be noted that, when calculation of the command speed (vᵥₓ, v_{vy}) is performed using Equation (1) in S410 and S412 (particularly S412), the speed vᵥ corresponding to the resultant force F₀ is obtained, and the speed vᵥ is decomposed into the speed vᵥₓ, v_{vy} in the X-axis and Y-axis directions to calculate the command speed (vᵥₓ, v_{vy}).

In S414, it is determined whether or not the position (Px, Py) of the operation unit 3 calculated in S320 is within the force sense indication area Af (see FIG. 10). When positive determination is made, the control mode for the X-axis and Y-axis direction drive motors 38, 30 is determined as PD control or P control in S416. When negative determination is made (when the position (Px, Py) is within the safety measure area As), the control mode for the X-axis and Y-axis direction drive motors 38, 30 is determined as PID control or PI control in S418.

Next, in S420, the CPU calculates the output current Ii, that is, the drive amount in accordance with the actual speed (vₓ, v_{y}) of the operation unit 3 calculated in S320, the command speed (vᵥₓ, v_{vy}) calculated in S410 or S412, and the control mode determined in S416 or S418, provides a command of the calculated output current Ii (duty) to the drive control unit 72, and terminates the drive command processing subroutine, and the process proceeds to S324 in FIG. 17.

Here, the calculation processing of the output current Ii in S420 will be briefly and supplementarily explained with reference to FIG. 13. FIG. 13A shows a concept of the drive motor control, and FIG. 13B shows the drive motor control in the present embodiment executed by the CPU. As shown in FIG. 13A, the CPU controls driving of the X-axis and Y-axis direction drive motors 38, 30 in the control modes of either a) PD control (Proportional-Differential Control) or P control (Proportional Control), or b) PID control (Proportional-Integral-Differential Control) or PI control (Proportional-Integral Control) so that the actual speed of the operation unit 3 follows the command speed.

Therefore, as shown in FIG. 13B, the CPU calculates the output current Ii in accordance with the determined control mode. That is, to calculate the output current Ii, when the control mode is determined as PD (P) control, the current proportional to the integral value of the deviation is not added, and when the control mode is determined as PID (PI) control, the current proportional to the integral value of the deviation is added. At this time, the CPU refers to a relational equation that is stored in the ROM of the MCU 71 and expanded in the RAM and represents the relationship among the command speed, the reduction gear ratio of the reduction gear unit 31 or the reduction gear unit 39, the rotation speed of the motor, and the output current (duty) to the motor. In the present embodiment, the CPU calculates the deviation from the rotation speed of the motor calculated one cycle before and the actual rotation speed of the motor detected this time (most recently).

In S324 of FIG. 17, data of the position (Px, Py) of the operation unit 3 calculated in S320, the resultant force F₀ (load) calculated in S404 of FIG. 18, the position (Px, Py) in the trajectory-load information I₂, and the resultant force F₀ at the position in the trajectory-load information I₂ is output to the display control unit 76, and the trajectory and the load variation of the operation unit 3 are displayed on the display device 80. The data of the position in the trajectory-load information I₂ and the resultant force F₀ are sequentially selected every 10 [ms] from the trajectory-load information I₂ (Px, Py, Fx, Fy, F₀) arranged in chronological order. As a result, the difference between the speed at which the user U operates the operation unit 3 in the load detection mode and the speed at which the user U operates the operation unit 3 in the active training mode is displayed in real time on the upper part of the screen of the display device 80.

Next, in S326, similarly to S108 of FIG. 15, it is determined whether or not the position (Px, Py) of the operation unit 3 is substantially the same value for a preset set time, thereby determining whether or not the movement of the operation unit 3 is completed. When negative determination is made, the process returns to S318 to continue the active training for the user U, and when positive determination is made, the process proceeds to S342.

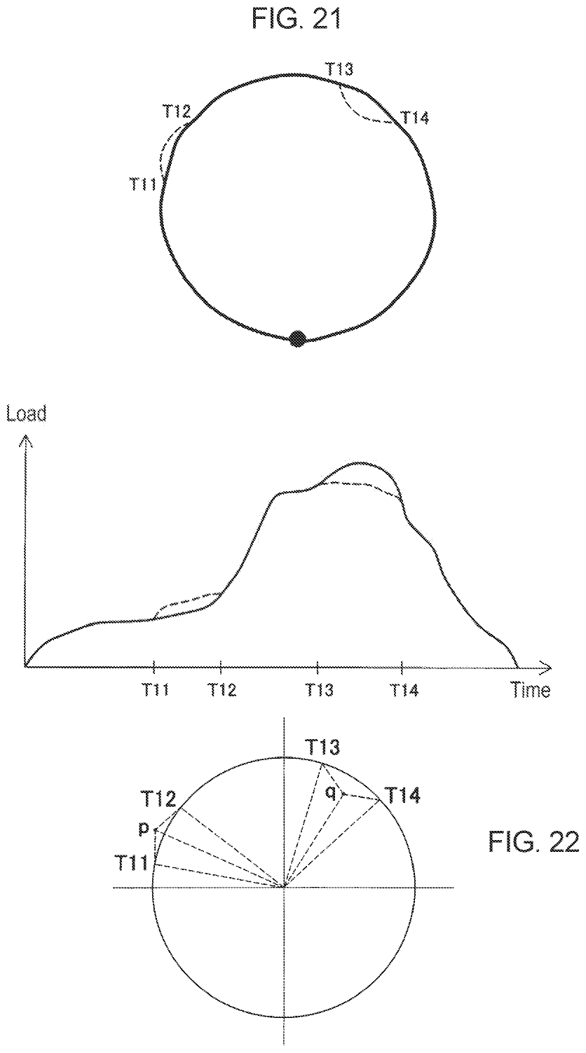

FIG. 21 schematically shows a screen displayed on the display device 80 at the time of positive determination in S326 (indicating the resultant force F₀ as an absolute value |F₀|), in which the trajectory (solid line) displayed in accordance with the trajectory-load information I₂ and the trajectory (broken line) when the user U traces the trajectory of the trajectory-load information I₂ is displayed at the upper part of the screen, and the load variation (solid line) displayed in accordance with the trajectory-load information I₂ and the load variation (broken line) when the user U traces the trajectory of the trajectory-load information I₂ taking the time axis as the horizontal axis is displayed at the lower part. The display control unit 76 may cause the display device 80 to display the solid lines and the broken lines, for example, in different colors after positive determination is made in S326 in accordance with an instruction from the CPU.

On the other hand, when negative determination is made in S308 of FIG. 17, processing in S328 to S340 (passive training mode) is executed. The processing in S328 to S340 is basically the same as the processing in S310 to S326 (active training mode). Hereinafter, different points will be described. Here, in the passive training mode, the forces (Fx, Fy) in the X-axis and Y-axis directions detected by the force sensor 51 is detected as component forces of the difference between the drive force of the X-axis and Y-axis direction drive motors 38, 30 and the force exerted on the operation unit 3 by the user U.

First, in the active training mode, the adjustment value information is acquired in S310 to S314 to calculate the predetermined value (the value of the radius of the static friction area 90), while in the passive training mode, since the purpose is the motion of the user U to follow the movement of the operation unit 3 moving automatically, the adjustment value is determined in advance and the predetermined value described above is not calculated. Therefore, the passive training mode does not include the steps corresponding to S310 to S314.

Further, in S328 corresponding to S316, it is determined whether or not passive training has started by monitoring the signal information and determining whether or not the forces (Fx, Fy) are applied to the operation unit 3. When positive determination is made, the driving of the X-axis and Y-axis direction drive motors 38, 30 is started via the drive control unit 72 in following 5330, and the operation unit 3 is positioned at the first position (Px, Py) constituting the trajectory-load information I₂. That is, the command speed is obtained by dividing the distance in each of the X-axis direction and the Y-axis direction between the first position (Px, Py) constituting the trajectory-load information I₂ and the home position (0, 0) by the movement time 10 [ms] therebetween, and the command speed is output to the drive control unit 72.

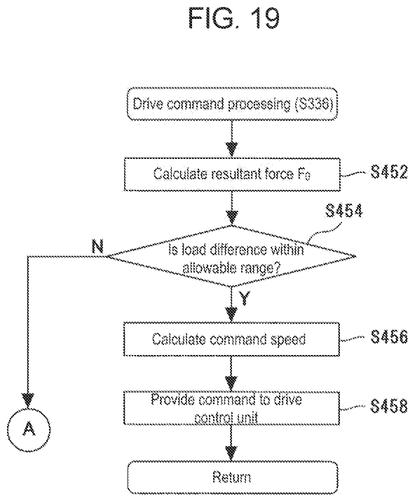

Further, the drive command processing in S336 corresponding to S322, as shown in FIG. 19, does not include steps corresponding to S402 and S414 to S418 of FIG. 18. This is also because, since the purpose of the passive training mode is the motion of the user U to follow the movement of the operation unit 3 moving automatically, the movement range of the operation unit 3 is limited to the force sense indication area Af shown in FIG. 10. Therefore, the control mode of the X-axis and Y-axis direction drive motors 38, 30 is determined to PD (P) control.

Further, in the drive command processing subroutine of FIG. 19, the command speed is calculated in S456 instead of S408 to S412 of FIG. 18. The command speed is calculated every 10 [ms] so as to actualize the position of the trajectory-load information I₂ read out in S302 of FIG. 17. That is, the command speed is obtained by dividing the distance in each of the X-axis direction and the Y-axis direction between the present position of the processing target of the trajectory-load information I₂ and the subsequent position of the trajectory-load information I₂ by the movement time 10 [ms] therebetween, and the command speed is output to the drive control unit 72. Therefore, Equation (1) is not used.

Further, in S340, similarly to S214 of FIG. 16, it is determined whether or not the movement of the operation unit 3 has been completed by determining whether or not the processing of positioning the operation unit 3 at the last position of the trajectory-load information I₂ has been performed. When negative determination is made, the process returns to S332 to continue the passive training, and when positive determination is made, the process proceeds to S342.

In S342, driving of the X-axis and Y-axis direction drive motors 38, 30 are stopped, and the motion training data is stored in the nonvolatile memory 74 to terminate the motion training routine in following S344. The motion training data is also stored when negative determination is made in S402, S406 of FIGS. 18 and S454 of FIG. 19 for reference of the upper limb conditions of the user U.

The motion training data includes motion training trajectory-load information I₃ obtained by adding the data of the position (Px, Py) of the operation unit 3 and the data of the forces (Fx, Fy, F₀) acting on the operation unit 3 calculated every 10 [ms], and in the active training mode, the data of the adjustment value determined in S314 and the predetermined value are further included. The motion training trajectory-load information I₃ is, for example, data of every 10 [ms] represented by (Px, Py, Fx, Fy, F₀) arranged in chronological order from the beginning to the end of the motion training.

In S208 of FIG. 16 (and S334 of FIG. 17), similarly to S320 of FIG. 17, the actual speed (vₓ, v_{y}) of the operation unit 3 is calculated from the count values of the encoders 38a, 30a included in the signal information, and in S204, similarly to S420 of FIG. 18, the actual speed (vₓ, v_{y}) and the command speed (vᵥₓ, v_{vy}) of the operation unit 3 are calculated, and the output current in the predetermined control mode (PD control or P control) is instructed to the drive control unit 72, but description thereof is omitted because it is not directly related to the present invention in the above.

### 3. Effects and the Like

Next, effects and the like of the motion training apparatus 1 of the present embodiment will be described.

### 3.1. Effects

In the motion training apparatus 1 of the present embodiment, it is determined whether or not the magnitude |F₀| of the resultant force F₀ is less than the predetermined value in S408 of FIG. 18. When positive determination is made, the command speed (vᵥₓ, v_{vy}) is calculated by the upper part of Equation (1). That is, the upper part of Equation (1) functions as an expression for limiting the drive amount of the X-axis and Y-axis direction drive motors 38, 30 (compared to the lower part of Equation (1)). Therefore, when the user U performs planar motion, it is possible to simulate static friction which prevents movement of the operation unit 3 in a steady state unless a force equal to or larger than a certain level is applied, and it is possible to realize a virtual friction force when the user U operates the operation unit 3. In addition, when the user U stops the operation unit 3, a virtual static force acts, and a feeling of strangeness such as smooth stopping can be prevented at the time of stopping the operation unit 3.

In addition, in the motion training apparatus 1 of the present embodiment, it is determined whether or not the magnitude |F₀| of the resultant force F₀ is less than the predetermined value in S408 of FIG. 18. When negative determination is made, the speed vᵥ corresponding to the resultant force F₀ is obtained by the lower part of Equation (1) in S412, and the command speed (vᵥₓ, v_{vy}) is calculated as decomposing the speed vᵥ into the speed vᵥₓ, v_{vy} in the X-axis and Y-axis directions. Therefore, as compared with the case in which the command speed vᵥₓ in the X-axis direction and the command speed v_{vy} in the Y-axis direction are calculated independently for the X-axis and the Y-axis, by the lower part of Equation (1), from the force Fx in the X-axis direction acting on the operation unit 3 and the force Fy in the Y-axis direction acting on the operation unit 3, the operability when moving the operation unit 3 in the oblique direction can be improved (see also Comparative Example 1 to be described later in 5. Test).

Further, in the motion training apparatus 1 of the present embodiment, since the parameters of the virtual model IM are configured to be adjustable (S310 to S314), motion training can be appropriately supported in accordance with the upper limb conditions of the user U. Further, since the CPU determines the parameters from the input (adjustment value) information according to the magnitude of the momentum and the static friction force for parameter inputting, the input operation can be facilitated.

Further, in the motion training apparatus 1 of the present embodiment, when the operation unit 3 is within the force sense indication area Af, the X-axis and Y-axis direction drive motors 38, 30 are controlled by PD (P) control (S414, S416, S420 of FIG. 18). Since the positional accuracy is improved by PID (PI) control, even when the virtual mass mᵥ of the operation unit 3 is reduced and the training load is set small, the vibration of the operation unit 3 can be suppressed (damped) in the force sense indication area Af, so that the operability of the operation unit 3 of the motion training apparatus 1 can be improved (the planar motion by the user U can be comfortably supported).

Further, in the motion training apparatus 1 of the present embodiment, when the operation unit 3 is within the safety measure area As, the X-axis and Y-axis direction drive motors 38, 30 are controlled by PID (PI) control (S414, S418, S420 of FIG. 18). Therefore, it is possible to eliminate the burden on the user U and the motion training apparatus 1 by preventing the operation unit 3 from colliding with the mechanical operation limit, and to appropriately ensure the movable area of the operation unit 3, that is, the area of the motion training area for the user U.

### 3.2. Modification

In the present embodiment, there is shown an example in which the command speed (vᵥₓ, v_{vy}) is actually calculated by the upper part of Equation (1) when the magnitude |F₀| of the resultant force F₀ is less than the predetermined value in S408, S410 of FIG. 18, but the present invention is not limited thereto. For example, when the magnitude |F₀| of the resultant force F₀ is less than the predetermined value, the command speed (vᵥₓ, v_{vy}) may be set to (0, 0), that is, the drive amounts of the X-axis and Y-axis direction drive motors 38, 30 may be set to 0 (excitation state). Even in such an aspect, the user U can feel the virtual frictional force without feeling strangeness when operating the operation unit 3.

Further, in the present embodiment, there is shown an example in which the predetermined value (see also S408 of FIG. 18) is actually calculated in S314 of FIG. 17, but the present invention is not limited thereto. The predetermined value may be set in advance.

Further, in the present embodiment, the virtual model IM using the friction coefficient μₖ as the parameter is exemplified, but the command speed (vᵥₓ, v_{vy}) may be calculated by a virtual model not using the friction coefficient μₖ. Such a virtual model can be configured by, for example, the following equation:

$$[ Expression 2 ]$$

$$\begin{matrix}{m}_{v} {\dot{v}}_{vi} = \{ \begin{matrix}0 & ( {F}_{o}^{2} \leq {μ}_{s}^{2} and {v}_{v}^{2} \leq {v}_{vsi}^{2} ) \\ - {c}_{v} {v}_{vi} & + {F}_{i} , ( else )\end{matrix} , ( i = x , y ) \\ Here , & ( 5 ) \\ {F}_{o}^{2} = {F}_{x}^{2} + {F}_{y}^{2} , & ( 6 ) \\ {v}_{v}^{2} = {v}_{vx}^{2} + {v}_{vy}^{2} , & ( 7 )\end{matrix}$$

The upper part of Equation (5) is a calculation formula of the command speed (vᵥₓ, v_{vy}) of the operation unit 3 when the resultant force F₀ is within the static friction area 90, and the lower part is a calculation formula of the command speed (vᵥₓ, v_{vy}) of the operation unit 3 when the resultant force F₀ is outside the static friction area 90. The parameters of Equations (5) to (7) are the same as those of the virtual model IM.

Further, in the present embodiment, in order to suppress the vibration of the operation unit 3 in the force sense indication area Af, there is shown an example in which both the X-axis and Y-axis direction drive motors 38, 30 are controlled by PD (P) control, but the present invention is not limited thereto. Only one of the X-axis and Y-axis direction drive motors 38, 30 (e.g., the Y-axis direction drive motor 38) may be controlled by PD (P) control and the other thereof may be controlled by PID (PI) control. Further, in the safety measure area As, only one of the X-axis and Y-axis direction drive motors 38, 30 (e.g., the Y-axis direction drive motor 38) may be controlled by PID (PI) control and the other thereof may be controlled by PD (P) control.

In the present embodiment, there is shown an example in which a six-axis force sensor using a commercially available strain gauge is used as the force sensor 51, but the present invention is not limited thereto. A two-axis or three-axis force sensor may be used or a strain gauge may be replaced with, for example, a capacitance type or an optical type. Furthermore, in the present embodiment, the strain-load conversion determinant may be simplified by using only Fx and Fy. Further, in the present embodiment, there is shown an example in which only Fx and Fy are used, but the force Fz in the Z-axis direction acting on the operation unit 3 may be monitored in the above-described signal information in S316 and S328 of FIG. 17 and determine whether or not the force Fz has been applied to the operation unit 3, thereby determining whether or not active training or passive training has started.

Further, in the present embodiment, as shown in FIGS. 20 and 21, there is shown an example in which the load variation with respect to the time axis is displayed on the display device 80, but the load variation may be displayed as a radar chart showing the direction and magnitude at the same time without the time axis. FIG. 22 shows an example of such a radar chart. In the example of FIG. 22, directions and magnitudes of the loads (resultant force F₀) are shown with reference to an origin at which the X-axis and the Y-axis intersect. Points p and q indicate the loads when the load deviates from the trajectory-load information I₂. When such a radar chart is used, it is not necessary to scroll the time axis even when the training time becomes long. Further, since the direction and the magnitude of the force acting on the operation unit 3 can be displayed at the same time, it is possible to confirm how much load is applied in which direction in a predetermined trajectory. In the examples shown in FIGS. 20 and 21, the resultant force F₀ including the positive/negative information may be displayed instead of the absolute value |F₀| of the resultant force F₀.

Further, in the present embodiment, there is shown an example in which information/data is uniformly stored in the nonvolatile memory 342 in S110 of FIG. 15, S216 of FIGS. 16, and S344 of FIG. 17. However, since the controller 70 includes the communication control unit 78, information/data may be transmitted to an external device. Further, for example, when the load detection routine is continued after the trajectory setting routine, the trajectory information I₁ obtained in the trajectory setting routine is temporarily stored in the work area of the MCU 71 and the trajectory information I₁ may be used in the load detection routine, so that the information/data may be stored in the nonvolatile memory 74 after it is inquired whether or not to store the information/data.

In addition, in the present embodiment, there is shown an example in which the position shown in FIG. 9 is the home position, but the present invention is not limited thereto. For example, the position of the home position may be changed by the CPU in accordance with the input dominant hand of the user U.

Further, the motion training apparatus 1 may have a reproduction mode for reproducing the content of the motion training mode. In the reproduction mode, for example, in S302 of FIG. 17, the motion training trajectory-load information I₃ stored in the nonvolatile memory 74 and, in the case of the active training mode, data of the adjustment value and the predetermined value that have already been determined/determined may be read out, and the processing from S304 to S314 may not be performed.

In the reproduction mode, a part of the content of the motion training may be reproduced. For example, the trajectory or the load variation shown in FIG. 21 may be displayed on the display device to select a part thereof, and the content of the motion training of only the selected part may be reproduced. The training instructor can confirm the movement range in which the user U is difficult to move the upper limb or is difficult to apply a force, and can create a motion training program suitable for the user U.

Further, in the present embodiment, there is shown an example in which all data is processed using the RAM of the MCU 71 as the work area, but a buffer memory for temporarily storing the processed data may be connected to the external bus of the MCU 71 as necessary. In the present embodiment, there is shown an example in which the input device 79 and the display device 80 are separately provided, but they may be integrated by using a touch panel or the like. In this case, the input control unit 75 and the display control unit 76 are also integrated.

Further, in the present embodiment, there is shown an example in which the signal processing IC of the signal processing unit 73 calculates (Fx, Fy, Fz, Tx, Ty, Tz) by performing the strain-load conversion matrix calculation, but the CPU may perform the calculation. In such an aspect, the signal processing unit 73 is connected to the above-described external bus via an A/D converter.

Further, in the present embodiment, there is shown an example in which a circular trajectory is traced, but the present invention is not limited thereto, and for example, a polygon such as a triangle or a trajectory of a Roman character or the like may be traced. Further, in the present embodiment, there is shown an example in which the operation unit 3 is actually moved in the trajectory setting routine and the values of the respective positions are used as the trajectory information I₁, but the entire trajectory data converted into data in advance may be input in advance and displayed on the display device 80 as the reference trajectory when the user U selects the trajectory setting mode. This also applies to the load detection routine and the motion training routine. Alternatively, a plurality of basic patterns may be stored in advance in the nonvolatile memory 74, and one basic pattern may be selected for the user U. Further, in the present embodiment, there is shown an example in which the motion training mode is executed after the trajectory setting mode and the load detection mode on the assumption of a person under rehabilitation, but in the case of a healthy person, the motion training mode may be immediately executed. In this case, it is desirable to display the reference trajectory described above on the display device 80.

Furthermore, in the present embodiment, there is shown an example in which the X-axis and Y-axis direction drive motors 38, 30 are stopped when the emergency stop button 10a is depressed, but in order to further enhance safety, a switching element may be inserted between a power supply unit (not shown) and the drive control unit 72, and the CPU may turn off the switching element when the default value of the state of the emergency stop button 10a indicates that the emergency stop button 10a is depressed.

Further, in the present embodiment, the bellows-shaped sheet is exemplified as the cover 4, but instead of this, for example, the cover 4 may be configured of a relatively flexible sheet made of resin or cloth, and may be accommodated in a roll mechanism arranged inside the front, rear, left, and right side edges of the apparatus main body 2 as being free to be wound and pulled out by a spring structure biased in a winding direction. This type of the roll mechanism has been widely used in a screen or the like covering a window of a vehicle or a building. The structure of the cover 4 is not limited to the bellows structure or the roll mechanism, and various conventionally known structures can be used.

Further, in the present embodiment, there is shown an example in which the Y-axis direction actuator 21 is arranged on the X-axis direction actuator 22, but the present invention is not limited thereto, and both thereof may be reversed in positional relationship, or may be arranged on the same plane with different structures. Further, in the present embodiment, there is shown an example in which the left-right reinforcement members 14a, 14b and the front-rear reinforcement members 13a to 13c are integrated as the reinforcement structure of the casing 6, but the left-right reinforcement members 14a, 14b and the front-rear reinforcement members 13a to 13c may not be integrated and may be separated in the vertical direction.

Further, in the present embodiment, there is shown a structure in which rotation of the motor shaft is prevented by the gear ratio of the reduction gear units 39, 31 at the time of stopping the X-axis and Y-axis direction drive motors 38, 30 and thereby the movement of the operation unit 3 is prevented, but, for example, an electromagnetic brake or the like may be arranged to stop the rotation and remain when the power supply to the X-axis and Y-axis direction drive motors 38, 30 is stopped.

Further, in the present embodiment, there is shown an example in which the handle member 49 is attached to the operation rod 48, but the present invention is not limited thereto, and the handle member 49 may be detachably attached to the operation rod 48. In such an aspect, the handle member 49 may be replaced with various members suitable for engagement with the upper or lower limbs of the user U, depending on the purpose of use of the motion training apparatus 1, the conditions of the user U, and the like. For example, if the hand of the user U cannot grasp the handle member 49 well, a member with a belt for fixing the hand (or upper limb) may be used. Accordingly, it is possible to transmit a force from the hand (or the upper limb) of the user U to the operation rod 48 to move the operation unit 3, or to receive a force from the moving operation unit 3 via the operation rod 48 to move the hand (or the upper limb). In addition, in the case of training the lower limb of the user U, similarly, a table on which the foot of the user is placed or a member with a belt for fixing the foot may be used instead of the handle member 49.

Further, in the present embodiment, there is shown an example in which the motion training apparatus 1 is placed substantially horizontally and used, but the apparatus main body 2 may be used in a state inclined in the front-rear direction or the left-right direction, for example, in order to perform sanding training. In this case, the motion training apparatus 1 may include an inclination sensor 87 (see FIG. 2) for detecting an inclination state thereof, that is, an inclination direction and an inclination angle. As the inclination sensor 87, for example, a gyro sensor can be used, but the present invention is not limited thereto. In such an aspect, the motion training apparatus 1 is installed, for example, on a separate support structure capable of adjusting the inclination angle, and the output signal of the inclination sensor 87 is input to the controller 70 and is used to control the output of at least one of the X-axis and Y-axis direction drive motors 38, 30 in accordance with the inclination direction of the motion training apparatus 1 and the magnitude of the inclination angle.

Further, in the present embodiment, the dimensions of the force sense indication area Af and the safety measure area As, the processing cycle, the maximum values of Fx and Fy, the maximum acceleration, the maximum speed, the threshold value, and the like are indicated by specific numerical values, but the present invention is not limited thereto, and it is obvious that arbitrarily numerical values can be used.

### 4. Operation Control of Operation Unit During Motion Training

When performing motion training using the motion training apparatus 1, it is not always easy for the user to constantly operate the operation unit 3 to move along the target trajectory set in advance by the controller 70. For example, when the movable range of the hand, the arm, the shoulder, or the like which operates the operation unit 3 is small, or when the force applied to the operation unit 3 by the user himself/herself cannot be well controlled or adjusted due to a physical disorder or the like of the user, the operation unit 3 may move as deviating from the predetermined target trajectory.

In such a case, in order to perform appropriate motion training for the user, it is preferable to perform control so as to return to the target trajectory from the deviated position while moving without unnecessarily stopping the operation unit 3. At this time, when the drive force applied from the X-axis and Y-axis direction drive motors 30, 38 to the operation unit 3 is too large, an excessive load is applied to the user and/or the motion training apparatus 1, in particular, the X-axis and Y-axis direction drive motors 30, 38 and the driving mechanism thereof, which may cause a safety problem.

The motion training apparatus 1 of the present embodiment controls the driving of the X-axis and Y-axis direction drive motors 30, 38 for moving the operation unit 3 so that appropriate motion training can be provided to the user while ensuring safety during motion training. The controller 70 performs switching of the drive control of the X-axis and Y-axis direction drive motors 30, 38 according to whether the motion training is in the passive training mode or the active training mode. Details will be described below.

### 4.1. Passive Training Mode

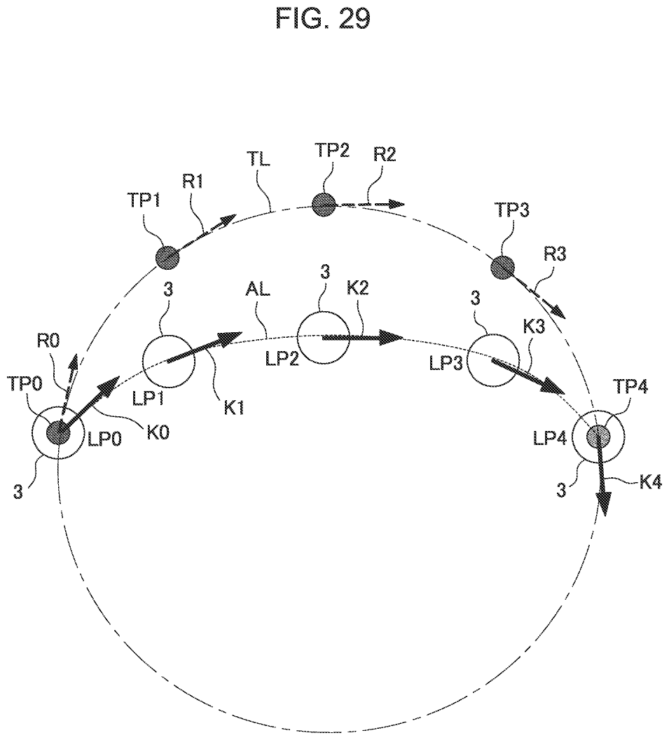

FIG. 29 shows a target trajectory TL in the passive training mode of the operation unit 3 set in advance by the controller 70 and an operation trajectory AL on which the operation unit 3 actually moves as deviating from the target trajectory TL due to the operation of the user U performing the passive training. In FIG. 29, the target trajectory TL is represented by a circular trajectory having a predetermined radius for simplicity of explanation. In contrast, the operation trajectory AL is represented in an arc shape which deviates inward from the circular target trajectory TL.

Small circles indicated by reference signs LP0 to LP4 on the operation trajectory AL indicate the trajectory position of the operation unit 3 to which the operation unit 3 actually moves. Bold line arrows K0 to K4 extending from the respective trajectory positions LP0 to LP4 indicate speed vectors actually acting on the operation unit 3. The small circle indicated by reference sign TP0 on the target trajectory TL indicates the current position of the operation unit 3, and each of the small circles indicated by reference signs TP1 to TP4 indicates the subsequent target position with respect to the current position of the operation unit 3, that is, the subsequent target positions corresponding to the trajectory positions LP1 to LP4, respectively. Broken line arrows R0 to R4 extending from the positions TP0, TP1 to TP4 on the target trajectory indicate speed vectors acting on the operation unit 3 moving along the target trajectory TL.

In the present embodiment, the positions TP0, TP1 to TP4 on the target trajectory TL of the operation unit 3 are set at constant time intervals with the current position TP0 as the starting point of motion training. The time interval Δt is set in advance so as not to cause any trouble in smooth motion training for the user in the passive training mode and the active training mode described later. At the same time as the start of motion training, the controller 70 starts clocking with the current position TP0 (LP0) as time t0 by a built-in counter and determines the current positions LP1 to LP4 on the operation trajectory AL of the operation unit 3 based on the number of pulses input from the encoders 38a, 30a for each time t1 to t4 of each position TP1 to TP4 calculated by adding Δt. Here, four target positions TP1 to TP4 and four trajectory positions LP1 to LP4 are shown in FIG. 29, this is merely for simplicity of explanation, and target positions are set more on the target trajectory in practice.

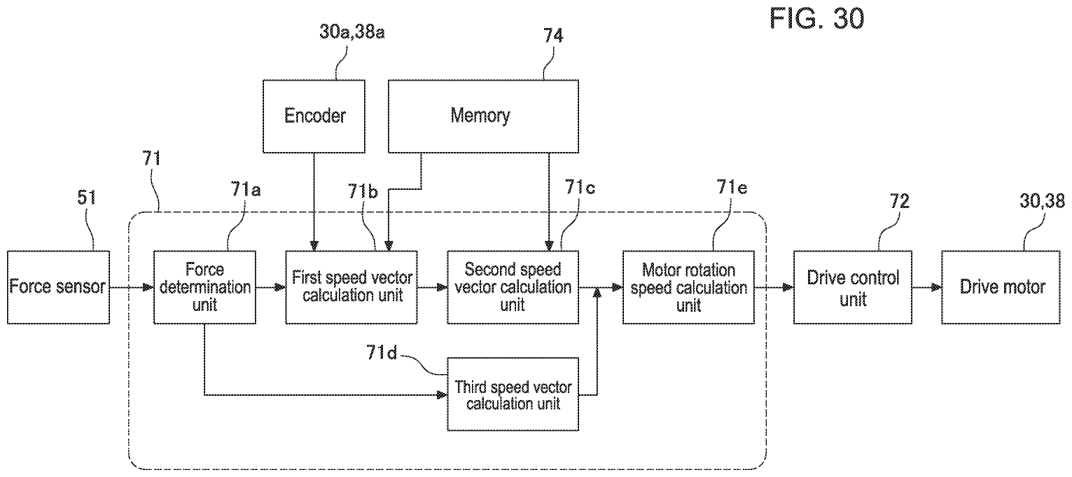

FIG. 30 is a circuit block diagram for explaining the drive control of the X- and Y-axis direction drive motors 38, 30 performed by the controller 70 in the motion training for the user executed in the passive training mode. The MCU 71 of the controller 70 obtains the speed of the operation unit 3 based on information input from the force sensor 51, the encoders 38a, 30a, and the nonvolatile memory 74, outputs a current value (output current Ii, duty) to the drive control unit 72, and controls power supply to the X-axis and Y-axis direction drive motors 38, 30.

In the present embodiment, the controller 70 performs switching of the drive control of the operation unit 3 between a case in which an input value from the operation unit 3 to the force sensor 51 is within a predetermined range set in advance and a case in which the input value exceeds the predetermined range. The predetermined range is set to a relatively small value so as not to cause an excessive burden on the user U even when the operation unit 3 driven to move along the target trajectory TL is forcibly moved by the X-axis and Y-axis direction drive motors 38, 30 as ignoring the resistance force received from the user U.

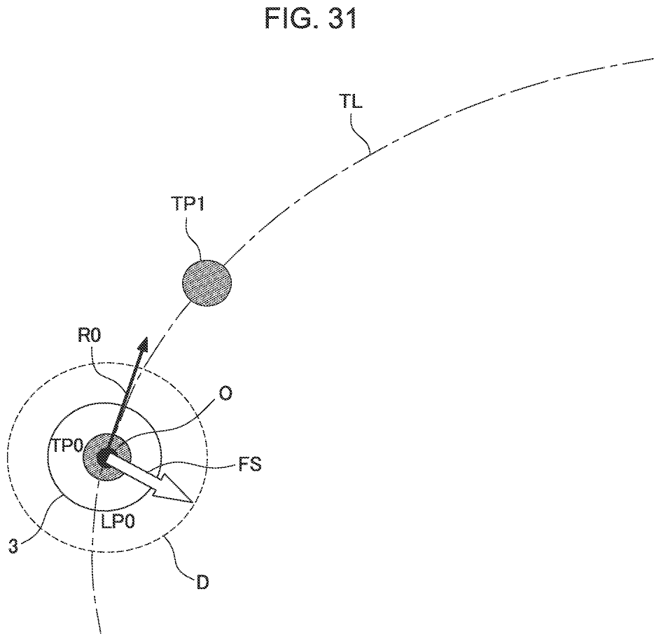

FIG. 31 shows a case in which the input value from the operation unit 3 to the force sensor 51 is within the predetermined range at the trajectory position LP0 on the operation trajectory AL. In FIG. 31, the trajectory position LP0 on the operation trajectory AL, which is the current position of the operation unit 3, is the same as the position TP0 on the target trajectory TL. The predetermined range is represented by a circle D whose outer contour is centered on the center O of the operation unit 3. A thick arrow FS extending from the center O of the operation unit 3 represents the direction and magnitude of the resistance force applied to the operation unit 3 by the user U, and the magnitude |FS| and the X-axis direction and Y-axis direction components representing the direction thereof are detected as input values to the force sensor 51.

As shown in FIG. 31, when the resistance force FS from the operation unit 3 is within the circle D, the magnitude |FS| of the input value from the operation unit 3 to the force sensor 51 is within the predetermined range. At this time, the controller 70 ignores the resistance force FS acting via the operation unit 3 from the user U, and controls driving of the operation unit 3. Specifically, the X-axis and Y-axis direction drive motors 38, 30 are controlled so that only the speed vector R0 directed in the tangent direction of the target trajectory TL is generated in the operation unit 3 at the current position LP0 (=TP0) on the target trajectory TL, and the operation unit 3 moves along the target trajectory TL. Therefore, the hand of the user U grasping the operation unit 3 performs motion training along the target trajectory TL together with the operation unit 3.

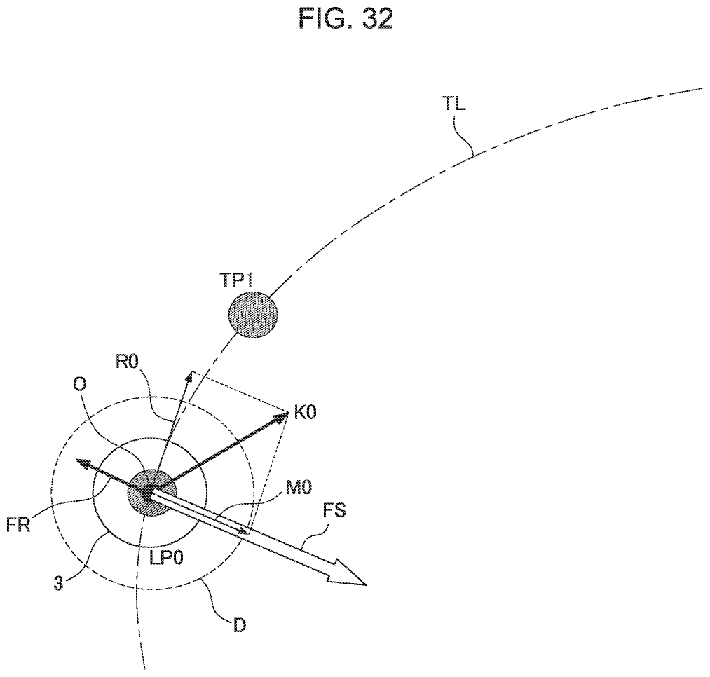

FIG. 32 shows a case in which the current position LP0 of the operation unit 3 is at the position TP0 on the target trajectory TL as in FIG. 31, and the resistance force FS from the operation unit 3 extends to the outside of the circle D. In this case, since the magnitude |FS| of the input value from the operation unit 3 to the force sensor 51 exceeds the predetermined range, the controller 70 controls the driving of the operation unit 3 in consideration of the magnitude of the input value.

Specifically, the X-axis and Y-axis direction drive motors 38, 30 are driven so as to generate a return force FR acting in a direction of returning the operation unit 3 to the position on the target trajectory TL against the resistance force FS acting so as to cause the operation unit 3 at the current position LP0=TP0 to deviate from the target trajectory TL. The return force FR is smaller than the resistance force FS, and since the operation unit 3 is on the target trajectory TL, the return force FR is generated in the opposite direction on the same line of action as the resistance force FS.

At this time, the difference between the resistance force FS and the return force FR can be expressed by the speed vector M0 in the same direction as the resistance force FS. As a result, a speed vector K0 which is a composite vector of the speed vector R0 directed in the tangent direction so as to move the operation unit 3 along the target trajectory TL and the speed vector M0 is generated on the operation unit 3. Therefore, the operation unit 3 moves not in the direction from the current position LP0=TP0 toward the subsequent target position TP1 but in the direction of the speed vector K0 at a speed corresponding to the magnitude thereof.

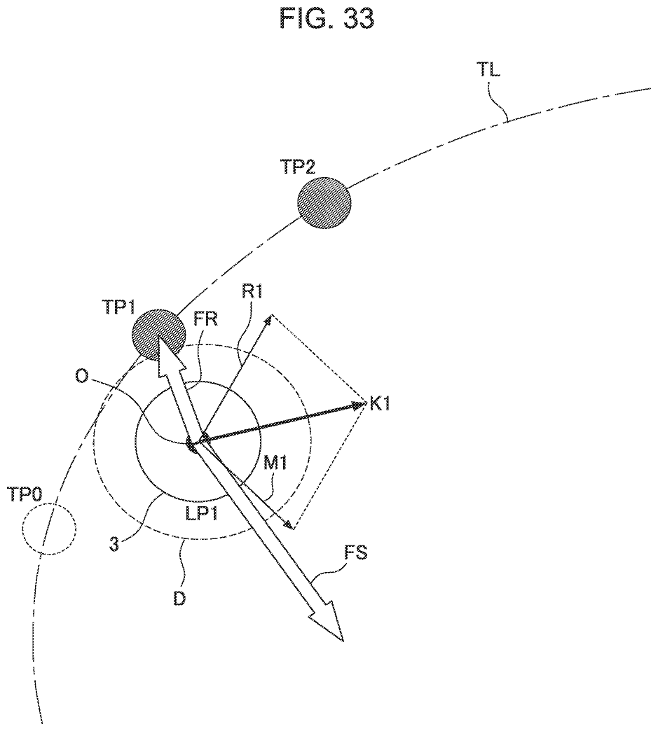

FIG. 33 shows a case in which the resistance force FS from the operation unit 3 extends to the outside of the circle D when the operation unit 3 moves from the current position (i.e., trajectory position LP0) in FIG. 32 to the subsequent trajectory position LP1. In this case as well, since the magnitude |FS| of the input value from the operation unit 3 to the force sensor 51 exceeds the predetermined range, the controller 70 controls the driving of the operation unit 3 in consideration of the magnitude of the input value.

Specifically, the X-axis and Y-axis direction drive motors 38, 30 are driven so as to generate the return force FR acting in a direction of returning the operation unit 3 to the target position TP1 on the target trajectory TL corresponding to the trajectory position LP1, that is, the position where the operation unit 3 should be if moving along the target trajectory TL against the resistance force FS acting to cause the operation unit 3 at the current position LP1 to deviate from the target trajectory TL. The return force FR is smaller than the resistance force FS, but becomes larger as the distance between the trajectory position LP1 and the corresponding target position TP1 increases, and is generated in a direction from the operation unit 3 toward the target position TP1 on the target trajectory TL.

At this time, a speed vector R1 directed from the currently located trajectory position LP1 to the subsequent target position TP2 and a speed vector M1 which is a composite vector of the resistance force FS and the return force FR are generated on the operation unit 3. As a result, as shown in FIG. 33, a speed vector K1 which is a composite vector of the speed vector R1 and the speed vector M1 is generated on the operation unit 3. Therefore, the operation unit 3 moves not in the direction from the currently located trajectory position LP1 toward the subsequent target position TP2 but in the direction of the speed vector K1 at a speed corresponding to the magnitude thereof.

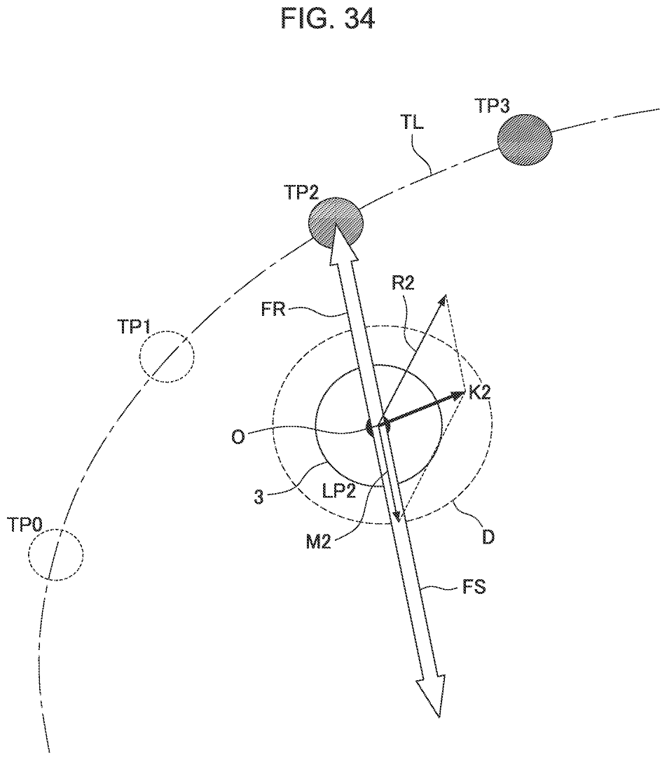

FIG. 34 shows a case in which the resistance force FS from the operation unit 3 extends to the outside of the circle D when the operation unit 3 moves from the current position LP1 in FIG. 33 to the subsequent trajectory position LP2. In this case as well, since the magnitude |FS| of the input value from the operation unit 3 to the force sensor 51 exceeds the predetermined range, the controller 70 controls the driving of the operation unit 3 in consideration of the magnitude of the input value.

Specifically, the X-axis and Y-axis direction drive motors 38, 30 are driven so as to generate the return force FR acting in a direction of returning the operation unit 3 to the target position TP2 on the target trajectory TL corresponding to the trajectory position LP2, that is, the position where the operation unit 3 should be if moving along the target trajectory TL against the resistance force FS acting to cause the operation unit 3 at the current position LP1 to deviate from the target trajectory TL. The return force FR is smaller than the resistance force FS, but since the distance between the trajectory position LP2 and the corresponding target position TP2 is larger than the distance between the trajectory position in FIG. 33 and the target position TP1, the return force FR is larger than the case in FIG. 33 and is generated in the direction from the operation unit 3 toward the target position TP2 on the target trajectory TL. In the example shown in FIG. 34, the return force FR is generated in the opposite direction on the same line of action as the resistance force FS.

At this time, a speed vector R2 directed from the currently located trajectory position LP2 to the subsequent target position TP3 and a speed vector M2 which is a composite vector of the resistance force FS and the return force FR are generated on the operation unit 3. As a result, as shown in FIG. 34, a speed vector K2 which is a composite vector of the speed vector R2 and the speed vector M2 is generated on the operation unit 3. Therefore, the operation unit 3 moves not in the direction from the currently located trajectory position LP2 toward the subsequent target position TP3 but in the direction of the speed vector K2 at a speed corresponding to the magnitude thereof.

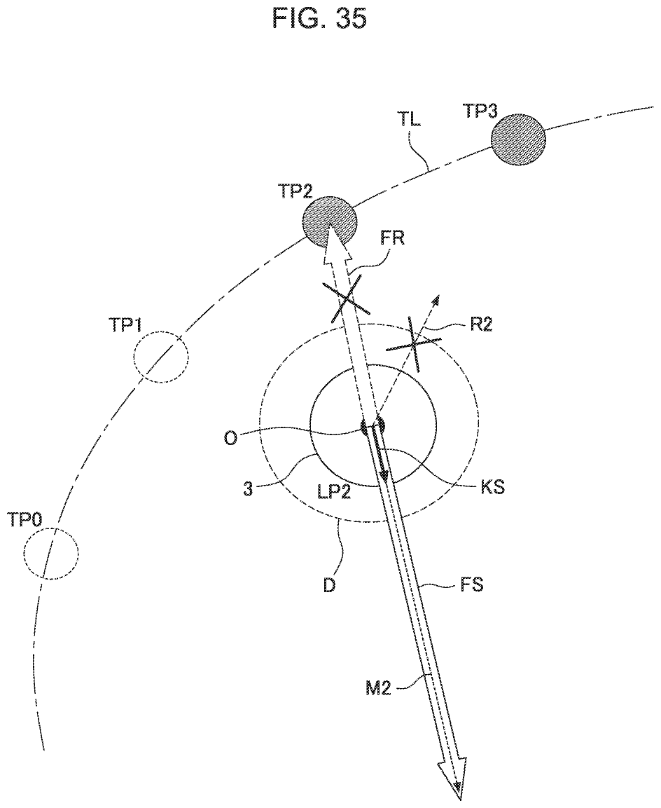

Next, FIG. 35 shows a case in which the operation unit 3 is located at the same trajectory position as FIG. 34, but the resistance force FS acting from the operation unit 3 not only extends to the outside of the circle D but also exceeds the predetermined threshold set in advance. At this time, as in the case of FIG. 34, since the resistance force FS is excessive compared to the return force FR generated in accordance with the distance between the trajectory position LP2 and the target position TP2, the speed vector M2 generated by the difference therebetween also becomes excessive, and there is a possibility that the movement of the operation unit 3 becomes too fast, and such a drive state is dangerous for the user.

Therefore, in the present embodiment, the predetermined threshold value is set to a magnitude of the resistance force FS that does not cause a dangerous drive state for the user even when the movement of the operation unit 3 becomes fast. When the magnitude of the resistance force FS exceeds the predetermined threshold value, the controller 70 sets the return force FR and the speed vector R2 from the trajectory position LP2 toward the subsequent target position TP3 to 0. Further, the controller 70 controls the X-axis and Y-axis direction drive motors 38, 30, so that a braking force larger than the return force FR generated in accordance with the distance between the trajectory position LP2 and the target position TP2 acts on the operation unit 3 in a direction opposite to the resistance force FS. Thus, the speed vector KS of the operation unit 3 is reduced, and the operation unit 3 can be moved slowly in the direction of the resistance force FS, thereby avoiding danger to the user.

In the case of FIG. 35, in the embodiment described above, the return force FR and the speed vector R2 are set to 0, but in another embodiment, the return force FR can be set to a value smaller than that in the case in which the return force FR is generated in accordance with the distance between the trajectory position LP2 and the target position TP2, and the speed vector R2 can be set to a value smaller than that in the case in which the speed vector R2 is directed from the trajectory position LP2 to the subsequent target position TP3. This also makes it possible to reduce the speed vector KS of the operation unit 3 and to move the operation unit 3 slowly, thereby avoiding danger to the user.

In order to control the movement of the operation unit 3 as described above in the passive training mode, the MCU 71 of the controller 70 includes a force determination unit 71a which receives, from the force sensor 51, the input value input to the force sensor 51, and determines the magnitude of the resistance force FS. The magnitude of the resistance force FS determined by the force determination unit 71a is output to a first speed vector calculation unit 71b, and the speed vectors M0 to M2 are calculated based on the current position information of the operation unit 3 input from the encoders 38a, 30a and the information of the target position input from the nonvolatile memory 74. The calculated speed vectors M0 to M2 are output to a second speed vector calculation unit 71c and are combined with the speed vectors R0 to R2 input from the nonvolatile memory 74 to calculate the speed vectors K0 to K2 of the operation unit 3. When the magnitude of the determined resistance force FS exceeds the predetermined threshold value, the force determination unit 71a outputs the determined resistance force FS to a third speed vector calculation unit 71d, and the speed vector KS of the operation unit 3 is calculated.

The speed vectors K0 to K2 and KS of the operation unit 3 are output to a motor rotation speed calculation unit 71e, and the rotation speed and rotation direction of the X-axis and Y-axis direction drive motors 38, 30 are calculated. The MCU 71 outputs the current value (output current Ii, duty) corresponding to the rotation speed and rotation direction of the X-axis and Y-axis direction drive motors 38, 30 calculated in this way to the drive control unit 72, and controls the driving of the X-axis and Y-axis direction drive motors 38, 30.

### 4.2. Active Training Mode

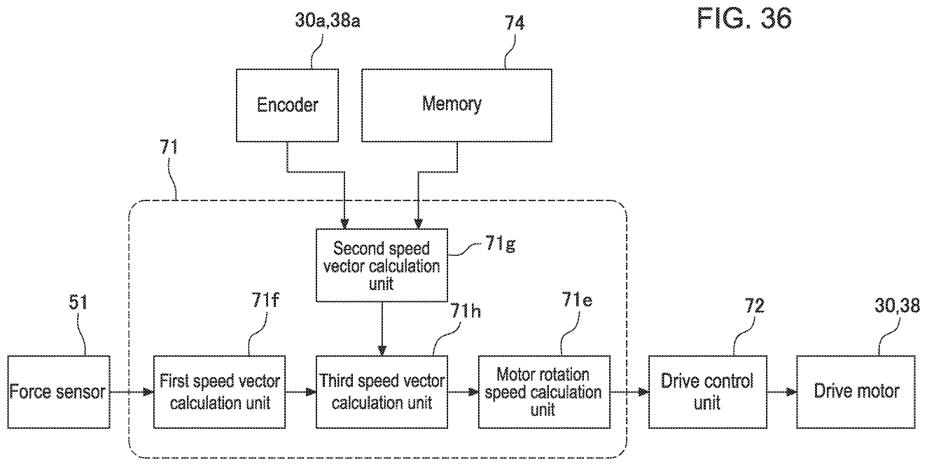

FIG. 36 is a circuit block diagram for explaining the drive control of the X- and Y-axis direction drive motors 38, 30 performed by the controller 70 in the motion training for the user executed in the active training mode. The MCU 71 of the controller 70 obtains the speed of the operation unit 3 based on information input from the force sensor 51, the encoders 38a, 30a, and the nonvolatile memory 74, outputs a current value (output current Ii, duty) to the drive control unit 72, and controls power supply to the X-axis and Y-axis direction drive motors 38, 30.

In the present embodiment, the controller 70 performs switching of the drive control of the operation unit 3 between a case in which the position of the operation unit 3 operated by the user U is within the predetermined target area set in advance and a case in which the position is outside the predetermined target area. The predetermined target area is a range of a constant distance from each point on the target trajectory TL set in advance, the constant distance being set to a value which can be regarded that the operation unit 3 is operated to substantially trace the target trajectory TL from the viewpoint of motion training.

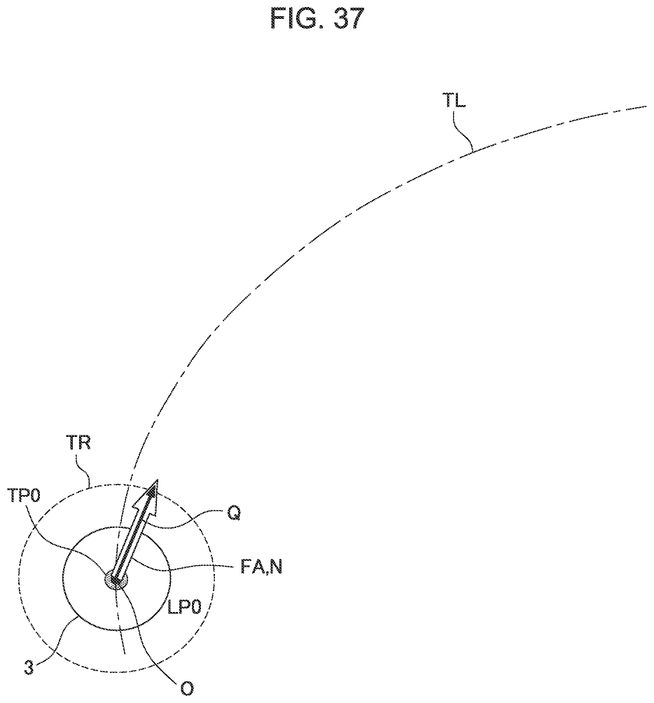

FIG. 37 shows a case in which the center O of the operation unit 3 is arranged to coincide with the start position TP0 on the target trajectory TL at the start of motion training in the active training mode. The predetermined target area is represented by a circle TR whose outer contour is centered on a point on the target trajectory TL (the starting position TP0 in FIG. 37). A thick arrow FA extending from the center O of the operation unit 3 represents the direction and magnitude of the operation force applied to the operation unit 3 by the user U, and the magnitude |FA| and the X-axis direction and Y-axis direction components representing the direction of the operation force FA are detected as input values to the force sensor 51. The operation force FA can be represented by a speed vector N generated on the operation unit 3 as shown in FIG. 37.

At the start of the motion training in FIG. 37, since the center O of the operation unit 3 is located on the target trajectory TL and within the target area TR, the controller 70 controls the X-axis and Y-axis direction drive motors 38, 30 so that a speed vector Q equal to the speed vector N is generated on the operation unit 3 based on the input value to the force sensor 51 corresponding to the operation force FA from the user U. In other words, the X-axis and Y-axis direction drive motors 38, 30 are driven so that the operation unit 3 can be moved without hindering the operation of the user U or exerting unnecessary force other than the operation force FA.

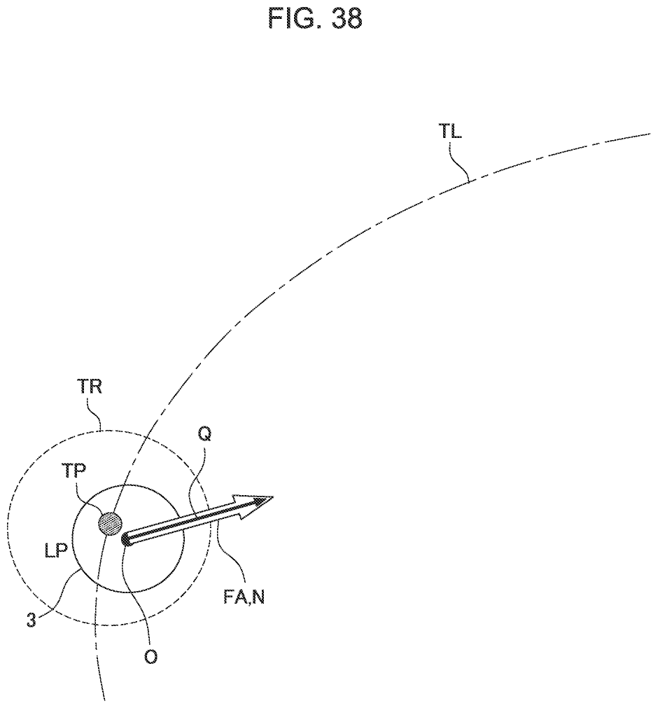

FIG. 38 shows a case in which the center O at the current position LP of the operation unit 3 moved from the start position TP0 shown in FIG. 37 by the operation of the user U deviates from the target position TP on the target trajectory TL but is within the target area TR. In this case, as in the case of FIG. 37, the controller 70 controls the X-axis and Y-axis direction drive motors 38, 30 so that the speed vector Q equal to the speed vector N is generated on the operation unit 3 based on the input value to the force sensor 51 corresponding to the operation force FA from the user U. Therefore, the operation unit 3 moves in the direction in which the user U moves based on the input value to the force sensor 51 corresponding to the operation force FA from the user U.

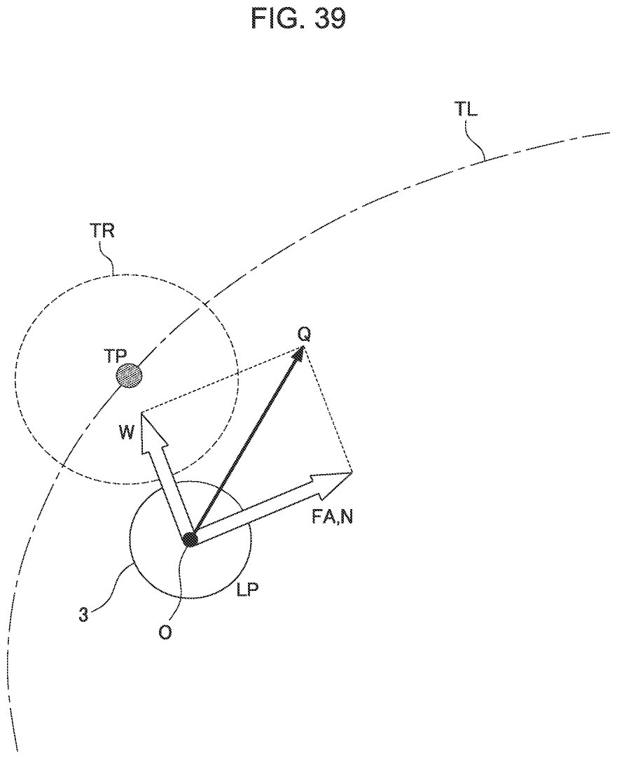

FIG. 39 shows a case in which the center O at the current position LP of the operation unit 3 moved from the position shown in FIG. 38 by the operation of the user U deviates from the target position TP. In this case, the controller 70 controls the X-axis and Y-axis direction drive motors 38, 30 so that a speed vector W acting in the direction of returning the operation unit 3 to the target area TR is generated in addition to the speed vector N based on the input value to the force sensor 51 corresponding to the operation force FA from the user U. Thus, the speed vector Q which is a composite vector of the speed vector N and the speed vector W is generated on the operation unit 3. Therefore, the operation unit 3 can be moved with the direction in which the user U moves being adjusted to return to the target area TR by adding the speed vector W to the operation force FA from the user U for assistance.

When the center O of the operation unit 3 returns into the target area TR from a position deviated from the target area TR shown in FIG. 39, the controller 70 sets the speed vector W which assists the operation force FA to 0 or a smaller value, and reduces the movement speed of the operation unit 3. Accordingly, it is possible to prevent the operation unit 3 from passing through the target area TR and moving to a deviated position on the opposite side.

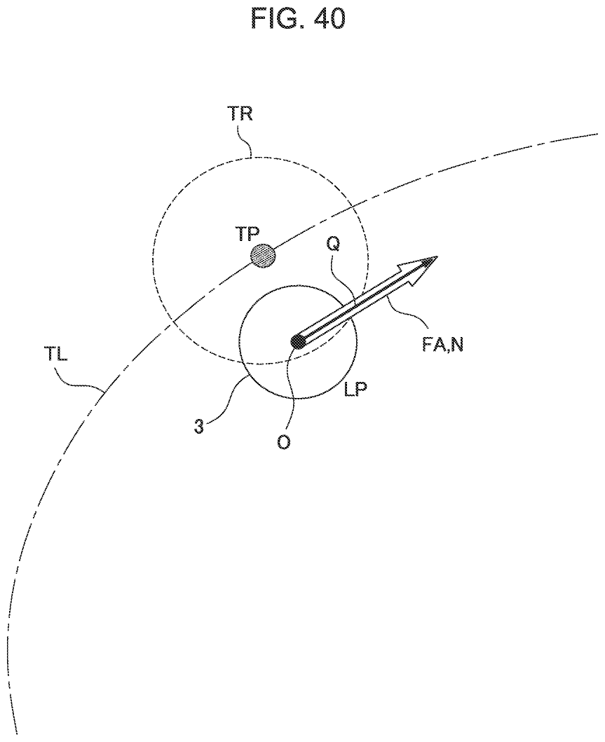

FIG. 40 shows a case in which the speed vector W is set to 0 when the center O of the operation unit 3 returns into the target area TR. By eliminating the assistance by the speed vector W, the force and speed vectors acting on the operation unit 3 become the same as the state of FIG. 38 described above. That is, the controller 70 controls the X-axis and Y-axis direction drive motors 38, 30 so that the speed vector Q equal to the speed vector N is generated on the operation unit 3 based on the input value to the force sensor 51 corresponding to the operation force FA from the user U, and the operation unit 3 moves in a direction in which the user U causes movement corresponding to the operation force FA from the user U.

In actual use, consideration should be given to a case in which the center O of the operation unit 3 does not immediately return into the target area TR, from the state in which the center O of the operation unit 3 is outside the target area TR as shown in FIG. 39, even by an assistance operation to the operation unit 3 on which the speed vector W is generated while the X-axis and Y-axis direction drive motors 38, 30 are driven. For example, during the assistance operation of returning the operation unit 3 from the state of FIG. 39 into the target area TR, the magnitude and/or direction of the operation force FA from the user U to the operation unit 3 may largely change for some reason.

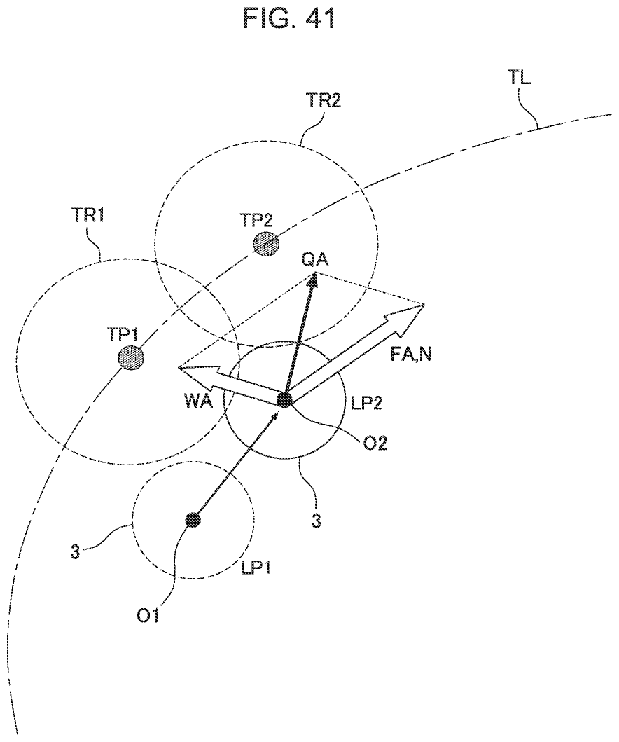

FIG. 41 shows a state in which the center O of the operation unit 3 is still outside the target area TR even when the speed vector W is applied in the state of FIG. 39. Here, reference signs LP2, O2 indicate the current position and the center of the operation unit 3 in FIG. 41, and reference signs LP1, O1 indicate the current position and the center of the operation unit 3 in FIG. 39 at the time point immediately before the current time point, respectively. Reference signs TP2, TR2 indicate the target position of the operation unit 3 and the target area at the time point of FIG. 41, and reference signs TP1, TR1 indicate the target position of the operation unit 3 and the target area at the time point of FIG. 39.

In this case, the controller 70 drives the X-axis and Y-axis direction drive motors 38, 30 so that the operation unit 3 is returned from the current position LP2 in FIG. 41 to the target position TP1 at the previous time point (target position TP in FIG. 39) again instead of the target position TP2 at that time point, and generates a speed vector WA for correcting the assistance operation. It is preferable that the resultant vector QA of the speed vector WA and the speed vector N due to the operation force FA from the user U to the operation unit 3 at this time point acts so as to direct the operation unit 3 toward the target area TR2 at this time point as shown in FIG. 41. The active training for the user U can be appropriately continued by correcting the assistance operation in this manner and quickly returning the operation unit 3 into the range of the target area TR.

In the embodiment according to FIG. 41 described above, the target position TP on the target trajectory TL is set to move in accordance with the movement of the operation unit 3 along the elapse of time during the training of the user U. Therefore, even when the speed vector WA is applied so as to return the operation unit 3 to the target position TP2 corresponding to the current position thereof, the operation unit 3 may not immediately return to the target area TR. In such a case, since the operation unit 3 continues to move for a long time while being outside the target area TR, it is not preferable in terms of training of the user U.

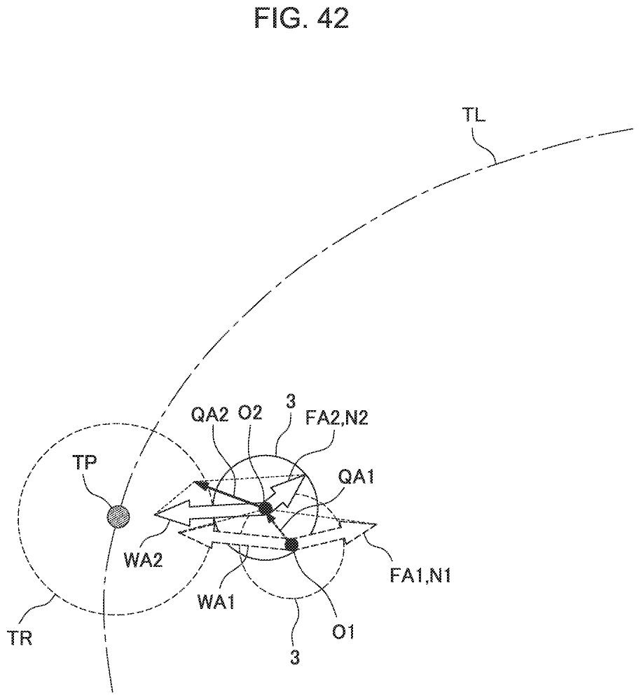

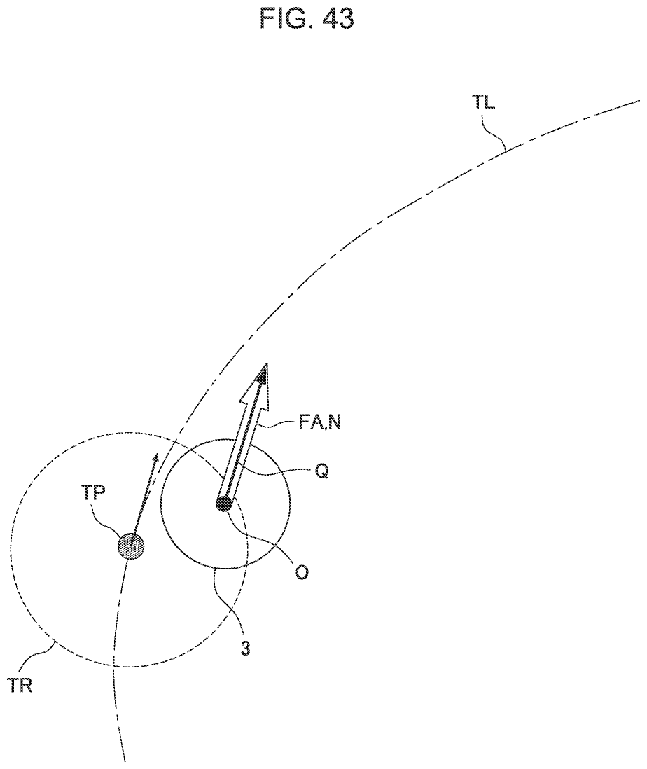

Therefore, in still another embodiment, it is possible to generate the speed vector WA for correcting the assistance operation so as to return the operation unit 3 to the target position at the previous time point (the target position at the time when the center position O of the operation unit 3 is outside the target area TR). A preferable method of controlling the assistance operation to the operation unit 3 in this manner will be described below with reference to FIGS. 42 and 43. In FIG. 42, in a state of being outside the target area TR, the position of the operation unit 3 at an earlier time point t1 is indicated by a broken line, and the position of the operation unit 3 at the subsequent time point t2 is indicated by a solid line. The reference sign O1 indicates the center position of the operation unit 3 at the time point t1, and the reference sign O2 indicates the center position of the operation unit 3 at the subsequent time point t2.

First, the controller 70 stops the movement of the target position TP on the target trajectory TL regardless of the elapse of time in the training of the user U in a state in which the operation unit 3 is outside the target area TR. Then, the controller 70 controls the X-axis and Y-axis direction drive motors 38, 30 so as to generate a speed vector WA1 in a direction in which the center O1 of the operation unit 3 is returned into the target area TR whose movement is stopped at the time point t1. At this time point t1, as shown by a broken line in FIG. 42, the resultant vector QA1 of the speed vector WA1 and the speed vector N1 due to the operation force FA1 of the user U to the operation unit 3 acts so as to direct the center position O1 of the operation unit 3 (broken line) toward the target area TR in which the movement is stopped. Therefore, at the time point t2, the center position O2 of the operation unit 3 (solid line) does not return into the target area TR, and is still at a position outside the target area TR.

Therefore, at the time point t2, the controller 70 repeatedly executes the above-described assistance operation at the time point t1. That is, the controller 70 controls the X-axis and Y-axis direction drive motors 38, 30 so as to generate a speed vector WA2 in a direction in which the center O2 of the operation unit 3 is returned into the target area TR in which the movement is stopped. As shown by the solid line in FIG. 42, the resultant vector QA2 of the speed vector WA2 and the speed vector N2 due to the operation force FA2 of the user U to the operation unit 3 is generated so as to direct the center position O2 of the operation unit 3 (solid line) toward the target area TR in which the movement is stopped. As a result, as shown in FIG. 43, the operation unit 3 can return the center position O thereof into the target area TR. According to the present embodiment, the assistance operation for generating the resultant vector QA2 is repeatedly performed until the center position O of the operation unit 3 returns into the target area TR. In other words, the controller 70 controls the X-axis and Y-axis direction drive motors 38, 30, so that the speed vector W toward the stopped target position TP continues to be generated until the center position O of the operation unit 3 returns into the target area TR after deviating from the target area TR.

When the center O of the operation unit 3 returns into the target area TR, as shown in FIG. 43, the controller 70 sets the speed vector W assisting the operation force FA of the user U to 0, and simultaneously starts moving the target position TP along the target trajectory TL corresponding to the elapse of time again. At this time, since there is no assistance of the speed vectors WA1, WA2 by the X-axis and Y-axis direction drive motors 38, 30, the operation unit 3 is moved in the operation direction by the operation force FA of the user U. The active training for the user U can be appropriately continued by correcting the assistance operation in this manner as well and quickly returning the operation unit 3 into the range of the target area TR. Here, the movement of the operation unit 3 is always recognized by the controller 70 as the speed vector N based on the input value to the force sensor 51 corresponding to the operation force FA of the user U.

When the center O of the operation unit 3 returns into the target area TR, the controller 70 can gradually reduce the speed vector W assisting the operation force FA of the user U to 0, instead of reducing the speed vector W to 0 at once. By the effect of the speed vector W being eliminated while being gradually reduced in this manner, the movement of the operation unit 3 within the target area TR immediately after returning from the outside of the target area TR can be stabilized more smoothly and quickly.

The correction of the assistance operation according to FIG. 41 and the correction of the assistance operation according to FIGS. 42 and 43 can be executed in combination. In this case, the controller 70 can selectively maintain or stop the movement of the target position TP on the target trajectory TL according to the movement state of the operation unit 3 recognized from the input value (position, operation force, speed, acceleration, and the like) to the force sensor 51. For example, when the separation distance of the center position O of the operation unit 3 from the target area TR, the operation force applied to the operation unit 3 at the outside of the target area TR, and the speed and acceleration of the operation unit 3 are within predetermined thresholds, the movement of the target position TP is maintained (embodiment of FIG. 41), and when they exceed the threshold values, the movement of the target position TP is stopped (embodiment of FIG. 42) and the assistance movement is executed.

In order to control the movement of the operation unit 3 as described above in the active training mode, the MCU 71 of the controller 70 includes the force determination unit 71a which receives, from the force sensor 51, the input value input to the force sensor 51, and determines the magnitude of the operation force FA. The magnitude of the operation force FA determined by the force determination unit 71a is output to a first speed vector calculation unit 71f, and the speed vector N is calculated based on the input value to the force sensor 51. When the operation unit 3 is outside the target area TR, a second speed vector calculation unit 71g calculates and outputs the speed vector W corresponding to the current position based on the current position information of the operation unit 3 input from the encoders 38a, 30a and the information of the target position input from the nonvolatile memory 74. When the operation unit 3 is within the target area TR, the speed vector W output by the second speed vector calculation unit 71g is 0.

A third speed vector calculation unit 71h calculates the speed vector Q by combining the speed vector N output from the first speed vector calculation unit 71f and the speed vector W output from the second speed vector calculation unit 71g. The calculated speed vector Q is output to the motor rotation speed calculation unit 71e, and the rotation speed and rotation direction of the X-axis and Y-axis direction drive motors 38, 30 are calculated. The MCU 71 outputs the current value (output current Ii, duty) corresponding to the rotation speed and rotation direction of the X-axis and Y-axis direction drive motors 38, 30 calculated in this way to the drive control unit 72, and controls the driving of the X-axis and Y-axis direction drive motors 38, 30.

### 5. Test

Next, a test performed using the motion training apparatus 1 of the embodiment will be described.

### 5.1. Test Content

In this test, a test subject operates the operation unit 3 of the motion training apparatus 1 so as to trace a circle (reference trajectory) having a radius of 0.107 m displayed on the display device 80 in the above-described active training mode. The content of the test was explained in advance for four healthy men in their 20s as test subjects, and the test was performed after informed consent was obtained.

In the test, the parameters of the virtual model IM and the control modes of the X-axis and Y-axis direction drive motors 38, 30 were set as shown in Table 1 below.

TABLE 1

| | | | μₛ | μₖ | Dead | Drive |
|---|---|---|---|---|---|---|
| | mᵥ [kg] | cᵥ [kg/s] | [N] | [N] | zone [N] | control |
| Example | 5 | 20 | 3 | 2 | — | P |
| Comparative Example 1 | 5 | 20 | — | — | 1 | PID |
| Comparative Example 2 | 2 | 10 | 3 | 2 | — | P |

That is, in Example, the parameters used in the virtual model IM were set to the virtual mass mᵥ of the operation unit 3: 5 [kg], the viscosity damping coefficient cᵥ: 20 [kg/s], the maximum static friction force μₛ: 3 [N], and the friction coefficient μₖ: 2 [N], and the control mode of the X-axis and Y-axis direction drive motors 38, 30 was set to P control (Kp=3×10⁴).

On the other hand, in Comparative Example 1, a virtual model in which the X-axis and Y-axis were independently configured and the dead zone and viscous resistance were simulated for each axis was used with the parameters set to virtual mass mᵥ of the operation unit 3: 5 [kg], the dead zone: 1 [N], and the viscous damping coefficient cᵥ: 20 [kg/s], and the control mode of the X-axis and Y-axis direction drive motors 38, 30 was set to PID control. Incidentally, it has been confirmed that when a virtual model simulating the dead zone and viscous resistance independently on each axis as in Comparative Example 1 is used, if the virtual mass mᵥ of the operation unit 3 is set to be smaller than 5 [kg], the operation unit 3 becomes vibrated during the operation and the operation becomes difficult to be performed. Therefore, the parameters shown in Comparative Example 1 are the minimum of the training load in the virtual model simulating the dead zone and viscous resistance independently on each axis.

Further, in Comparative Example 2, in order to minimize the training load, the parameters used in the virtual model IM were set to the virtual mass mᵥ of the operation unit 3: 2 [kg], the viscosity damping coefficient cᵥ: 10 [kg/s], the maximum static friction force μₛ: 3 [N], and the friction coefficient μₖ: 2 [N], and the control mode of the X-axis and Y-axis direction drive motors 38, 30 was set to P control (Kp=3×10⁴).

### 5.2. Test Result

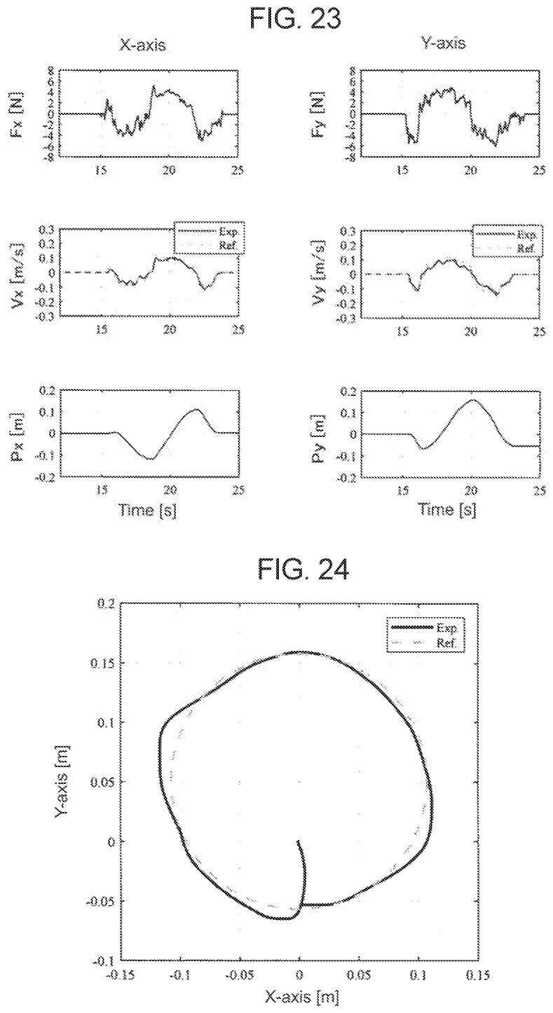

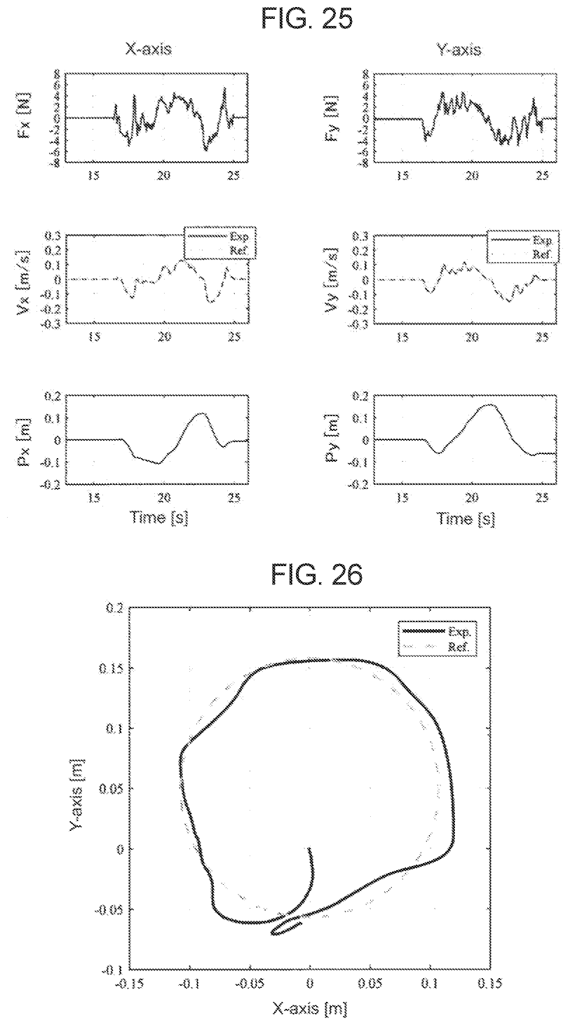

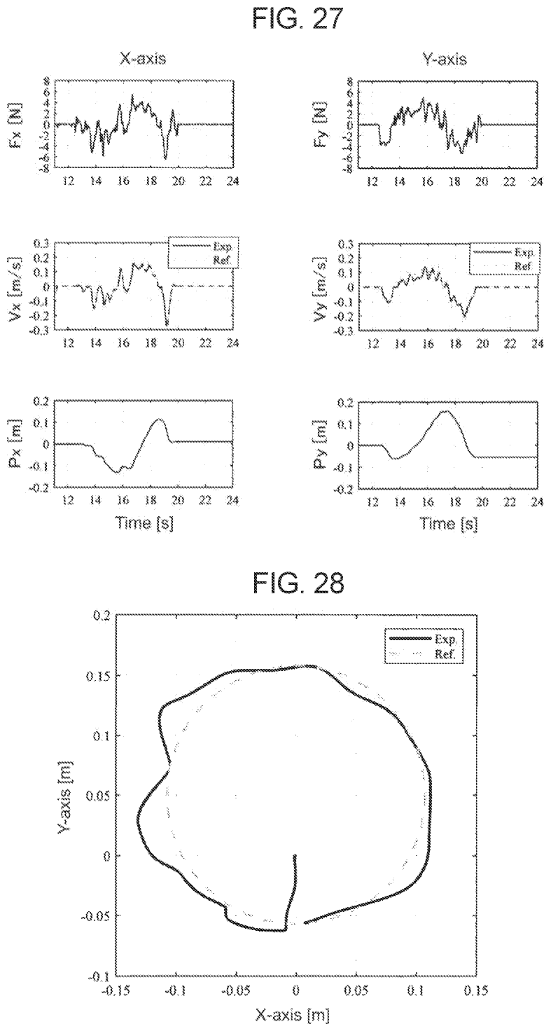

Next, the test results of this test are shown in FIGS. 23 to 28. FIGS. 23 to 28 show the test results of one of the four subjects, and FIGS. 23 and 24 show the test results of Example 1, FIGS. 25 and 26 show the test results of Comparative Example 1, and FIGS. 27 and 28 show the test results of Comparative Example 2. In FIGS. 23, 25 and 27, the graphs on the left side are the test results for the X-axis, and the graphs on the right side are the test results for the Y-axis. The upper graph shows the force acting on the operation unit 3, the middle graph shows the speed of the operation unit 3, and the lower graph shows the position of the operation unit 3. Further, in FIGS. 24, 26 and 28, the solid line is the trajectory of the operation unit 3, and the broken line is the reference trajectory referred to by the user U during operation.

### 5.3. Evaluation

As shown in FIGS. 25 and 26, in the test results of Comparative Example 1 using a virtual model simulating the dead zone and viscous resistance for each axis independently configured, since the reaction force due to the dead zone is increased with respect to the operation in the oblique direction, it can be confirmed that the trajectory of the operation unit 3 is linear. In contrast, as shown in FIGS. 23 and 24, in the test results of Example using the virtual model IM simulating the static friction in the plane motion, since the virtual friction force is given with respect to the motion direction, a state close to the actual wiping training is provided, and the trajectory closer to a circle is drawn. Further, although the magnitude of the force acting on the operation unit 3 was about 4 [N] in both Example and Comparative Example 1, the speed of the operation unit 3 was slightly suppressed in Example using the virtual model IM simulating the static friction in the planar motion, and it can be confirmed that a smooth operation was performed. Further, as shown in FIGS. 27 and 28, in the test results of Comparative Example 2 in which the training load was minimized, it can be confirmed that the speed of the operation unit 3 increased and it was difficult to accurately draw the circular trajectory.

In addition, as a result of questionnaire survey conducted on the test subjects after the test, three subjects answered that Example using the virtual model IM in which the static friction in the planar motion was simulated was easiest to operate, and that Comparative Example 2 in which the training load was minimized was difficult to operate.

From the above results, it is confirmed that Example using the virtual model IM simulating the static friction in plane motion creates a high presence feeling for plane motion such as wiping training, and good operability can be obtained. It was also confirmed that the training load can be adjusted freely by changing the parameters (adjusted values) such as the virtual mass mᵥ. On the other hand, it was also confirmed that the operability is impaired when the training load is set too small.

As described above, the present invention provides a motion training apparatus capable of simulating planar motion for a user without feeling strangeness, and therefore, contributes to manufacture and sale of a motion training apparatus, and thus has industrial applicability.

This application claims the benefit of Japanese Patent Application No. 2020-200787 which is incorporated herein by reference.

1. A motion training apparatus, comprising:
an operation unit configured to be movable in an XY plane;
a drive unit including an X-axis direction drive motor and a Y-axis direction drive motor, and configured to drive the operation unit in the XY plane;
a force sensor configured to detect a force Fx in an X-axis direction and a force Fy in a Y-axis direction acting on the operation unit from a user operating the operation unit;
a position detection means configured to detect a position of the operation unit in the XY plane; and
a controller configured to control the X-axis direction drive motor and the Y-axis direction drive motor,
wherein the controller controls the X-axis direction drive motor and the Y-axis direction drive motor in accordance with a first speed vector based on a magnitude of a resultant force F₀ of the force Fx in the X-axis direction and the force Fy in the Y-axis direction detected by the force sensor when the position detection means detects that the position of the operation unit moving in the XY plane due to operation of the user is within a predetermined area, and controls the X-axis direction drive motor and the Y-axis direction drive motor so that the operation unit moves in accordance with the first speed vector and a second speed vector acting to return the operation unit into the predetermined area when the position detection means detects that the position of the operation unit moving in the XY plane due to operation of the user is outside the predetermined area.

2. The motion training apparatus according to claim 1,
wherein the predetermined area is set within a range defined by a predetermined distance from a predetermined trajectory on which the operation unit is moved along the predetermined trajectory.

3. The motion training apparatus according to claim 2,
wherein, at a second time point after a predetermined time elapses from a first time point at which the X-axis direction drive motor and the Y-axis direction drive motor are controlled to move the operation unit having been outside the predetermined area in accordance with the first speed vector and the second speed vector, the controller reduces a magnitude of the second vector when the position detection means detects that the position of the operation unit has returned into the predetermined area.

4. The motion training apparatus according to claim 3,
wherein the controller reduces the magnitude of the second speed vector to 0.

5. The motion training apparatus according to claim 2,
wherein, at a second time point after a predetermined time elapses from a first time point at which the X-axis direction drive motor and the Y-axis direction drive motor are controlled to move the operation unit having been outside the predetermined area in accordance with the first speed vector and the second speed vector, when the position detection means detects that the position of the operation unit has not returned into the predetermined area, the controller controls the X-axis direction drive motor and the Y-axis direction drive motor so that the operation unit moves in accordance with the first speed vector based on the magnitude of the resultant force F₀ of the force Fx in the X-axis direction and the force Fy in the Y-axis direction detected at the second time point by the force sensor and a second speed vector acting to return the operation unit at the second time point into the predetermined area at the first time point.
